(19) United States
(12) Patent Application Publication
(10) Pub. No.: US 2026/0138374 A1
(43) Pub. Date: May 21, 2026

(54) LIQUID CIRCULATION APPARATUS, LIQUID DISCHARGE APPARATUS, AND PRINT APPARATUS

(71) Applicant: CANON KABUSHIKI KAISHA, Tokyo (JP)

(72) Inventors: YUJI TAMARU, Tokyo (JP); YOSUKE TAKAGI, Kanagawa (JP); HISAO OKITA, Kanagawa (JP); TOMOO IIZUMI, Kanagawa (JP); NORIYUKI KIRIHARA, Tokyo (JP); KOICHI KUBO, Kanagawa (JP); KAZUYA YOSHII, Kanagawa (JP); KIMIYUKI HAYASAKI, Kanagawa (JP)

(21) Appl. No.: 19/385,427

(22) Filed: Nov. 11, 2025

(30) Foreign Application Priority Data
Nov. 20, 2024 (JP) 2024-202256

(51) Int. Cl. B41J 2/175; B41J 2/045; B41J 2/18

(52) U.S. Cl. CPC B41J 2/17596; B41J 2/0455; B41J 2/0457; B41J 2/04573; B41J 2/04581; B41J 2/18

(57) ABSTRACT

A liquid discharge apparatus includes a piezoelectric unit including a first electrode, a second electrode, and a piezoelectric element arranged between the first electrode and the second electrode, a drive-control unit that controls the distortion generated in the piezoelectric unit in a driving cycle including a first period and a second period, and a diaphragm unit including a vibrating plate that vibrates in response to the distortion generated in the piezoelectric unit, and a pressure chamber, the diaphragm unit circulating liquid flowing in and out of the pressure chamber by the vibrations of the vibrating plate. The first period includes a period during which the driving voltage supplied to either one of the first electrode and the second electrode is cut off, and the second period includes a period during which no potential difference occurs between the first electrode and the second electrode.

### BACKGROUND

### Field of the Technology

The present disclosure relates to a liquid discharge apparatus that discharges liquid while circulating the liquid.

### Description of the Related Art

Conventionally, in the inkjet printer field, technologies have been known that circulates liquid (also referred to as ink) in a circulation channel communicating with a discharge orifice. In addition, Japanese Patent Laid-Open No. 2019-137013 (hereinafter referred to as Literature 1) discloses technologies of obtaining liquid circulating capability by circulating liquid with a piezoelectric pump.

However, It is assumed that the liquid circulating capability is maintained by the technologies described in Literature 1, there might be a risk that the occurrence rate of migration failure (details will be described later) increases, and it is assumed that there might be cases where the liquid circulating capability and suppression of migration failure cannot be achieved.

### SUMMARY

The present disclosure is directed to enable achieving of maintaining of the liquid circulating capability and suppression of migration failure.

According to an aspect of the present disclosure, there is provided a liquid circulation apparatus comprising: a piezoelectric unit including a first electrode, a second electrode facing the first electrode, and a piezoelectric element arranged between the first electrode and the second electrode; a drive-control unit for controlling, in a state of a driving voltage generating distortion in the piezoelectric unit supplied to the first electrode and the second electrode, the distortion generated in the piezoelectric unit in a driving cycle including a first period and a second period; and a diaphragm unit including a vibrating plate for vibrating in response to the distortion generated in the piezoelectric unit, and a pressure chamber for being transmitted vibrations of the vibrating plate, the diaphragm unit circulating liquid flowing in and out of the pressure chamber by the vibrations of the vibrating plate, wherein the first period includes a period during which the driving voltage supplied to either one of the first electrode and the second electrode is cut off, and the second period includes a period during which no potential difference occurs between the first electrode and the second electrode.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective view of a liquid discharge apparatus.

FIG. 1B is a block diagram of a control system of the liquid discharge apparatus.

FIG. 2 is an exploded perspective view of a liquid discharge head in FIG. 1A and FIG. 1B according to a first embodiment.

FIG. 3 is a schematic configuration diagram of an ink circulation unit in FIG. 2 according to the first embodiment.

FIG. 4 is a schematic diagram of an ink circulation path that circulates the liquid by a circulation pump in FIG. 3 according to the first embodiment.

FIG. 5 is a diagram illustrating an example of wiring of the circulation pump in FIG. 4 according to the first embodiment.

FIG. 6 is a cross-sectional schematic diagram of the circulation pump in FIG. 5 according to the first embodiment.

FIG. 7 is a diagram illustrating an example of a pump driving circuit that drives the circulation pump in FIG. 6 according to the first embodiment.

FIG. 8 is a diagram illustrating an example of a booster circuit in FIG. 7 according to the first embodiment.

FIG. 9 is a diagram illustrating an example of an output switching circuit in FIG. 7 according to the first embodiment.

FIG. 10 is a diagram for describing a timing chart of a control signal that controls the pump driving circuit according to the first embodiment.

FIG. 11 is a diagram for describing a timing chart of a control signal that controls a pump driving circuit according to a second embodiment.

FIG. 12 is a diagram for describing a timing chart of a control signal that controls a pump driving circuit according to a third embodiment.

FIG. 13 is a diagram for describing a timing chart of a control signal that controls a pump driving circuit according to a fourth embodiment.

FIG. 14 is a diagram illustrating an example of a pump driving circuit that drives the circulation pump in FIG. 6 according to a fifth embodiment.

FIG. 15 is a diagram illustrating an example of a step down circuit in FIG. 14 according to the fifth embodiment.

FIG. 16 is a diagram illustrating an example of an output switching circuit in FIG. 14 according to the fifth embodiment.

FIG. 17 is a diagram for describing a timing chart of a control signal that controls the pump driving circuit according to the fifth embodiment.

FIG. 18 is a diagram illustrating an example of a pump driving circuit that drives the circulation pump in FIG. 6 according to a sixth embodiment.

FIG. 19 is a diagram illustrating an example of a booster circuit in FIG. 18 according to the sixth embodiment.

FIG. 20 is a diagram for describing a timing chart of a control signal that controls the pump driving circuit according to the sixth embodiment.

FIG. 21 is a diagram illustrating an example of a pump driving circuit that drives the circulation pump in FIG. 6 according to a seventh embodiment.

FIG. 22 is a diagram illustrating an example of a pump driving circuit that drives the circulation pump in FIG. 6 according to an eighth embodiment.

### DESCRIPTION OF THE EMBODIMENTS

Hereinafter, preferred embodiments of the present disclosure will be described in detail with reference to the accompanying drawings. It should be noted that the following embodiments do not limit the matters of the present disclosure, and not all combinations of features described in the following embodiments are necessarily essential to the solutions of the present disclosure. It should be noted that the same reference numbers are given to the same components.

### Overview

In these years, in the inkjet printer field, liquid discharge head scanning-type liquid discharge apparatuses are used. It is required for the liquid discharge head scanning-type liquid discharge apparatuses to output high-quality prints. For example, a special ink may be used according to a recording medium for outputting high-quality prints. An ink circulation-type liquid discharge apparatus is required as a liquid discharge head scanning-type liquid discharge apparatus that can use such a special ink very well. Specifically, in order to circulate the ink, an ink supply channel and an ink collection channel are provided in the ink circulation-type liquid discharge apparatus. The ink circulation-type liquid discharge apparatus obtains the circulatory flow of the ink by generating the pressure difference between the ink supply channel and the ink collection channel. More specifically, the ink circulation-type liquid discharge apparatus includes a piezoelectric actuator that functions as a piezoelectric pump, and a control circuit, in order to generate the pressure difference between the ink supply channel and the ink collection channel. The piezoelectric actuator circulates the liquid stored in a supply tank for an inkjet head that functions as a liquid discharge head. The control circuit controls the driving voltage for driving the piezoelectric actuator by controlling the length of the time period of the electrical current applied to the piezoelectric actuator.

However, even in a time period other than charging and discharging, the driving voltage is always applied to the piezoelectric actuator. As a result of extensive research by the inventors of the present disclosure, the phenomenon has been discovered in which the occurrence rate of migration failure increases as the application time period of the driving voltage applied to the piezoelectric actuator progressed. In a case where the application time period of the driving voltage is a factor, it is possible to control the time period during which the power is applied to the piezoelectric actuator so as to reduce the driving voltage. In the meanwhile, there is a risk that the liquid circulating capability is decreased by reducing the driving voltage. That is, in the case where the piezoelectric actuator is operated, migration failure progresses, and in the case where the driving voltage is reduced, although migration failure can be avoided, the liquid circulating capability of the piezoelectric actuator as a piezoelectric pump is decreased. Therefore, it is difficult to achieve both suppression of progress of migration failure and maintaining of the liquid circulating capability.

Here, migration failure will be described. A piezoelectric actuator includes a piezoelectric element, two electrodes arranged on both sides of the piezoelectric element, and a vibrating plate arranged on one of the two electrodes. Since the piezoelectric actuator is used as a piezoelectric pump, the vibrating plate is arranged at a position at which the vibrating plate is in contact with liquid. Therefore, the usage environment of the piezoelectric actuator becomes highly humid. Under the highly humid usage environment, evaporated moisture penetrates into the piezoelectric element. Moreover, since the condition that a voltage is applied to the highly humid environment by the driving voltage applied between the two electrodes is biased, the piezoelectric element, which is originally an insulator, is locally energized. In a case where the piezoelectric element is locally energized, since a sufficient potential difference cannot be applied to the piezoelectric element, the function of the piezoelectric actuator as the piezoelectric pump is declined. That is, in a case where a metal is in contact with an insulating material under the condition that a voltage is applied to the metal, as the insulating material absorbs moisture, metal components move on the insulating material. A failure caused by a decrease in the insulation resistance value between the electrodes in a highly humid environment and under the condition that a voltage is applied as described above is referred to as migration failure. Migration failure as described above causes a short circuit between the electrodes, which leads to failure of an electronic device.

Therefore, in the present disclosure, in a state where the driving voltage is supplied between the above-described two electrodes, the distortion generated in the piezoelectric pump is controlled by a driving cycle including a first period and a second period. The first period includes a period during which the driving voltage supplied to either one of the two electrodes is cut off. The second period includes a period during which the driving voltage is simultaneously supplied to each of the two electrodes. According to such a configuration, in the first period, since the driving voltage supplied to either one of the two electrodes is cut off, a potential difference between the potential of the driving voltage and the ground potential occurs between the two electrodes. Therefore, in the first period, it becomes possible to generate distortion in the piezoelectric pump. Accordingly, the liquid circulating capability is maintained. In addition, in the second period, since the driving voltage is simultaneously supplied to each of the two electrodes, no potential difference occurs between the two electrodes. In a case where no potential difference occurs between the two electrodes, it does not mean that a voltage is applied between the two electrodes. Therefore, in the second period, even in a case where the piezoelectric pump is in a highly humid environment, the piezoelectric pump will not be under the condition that a voltage is applied. Therefore, migration failure can be suppressed. Accordingly, by controlling the distortion generated in the piezoelectric pump by the driving cycle including the first period and the second period, it is possible to achieve maintaining of the liquid circulating capability and suppression of migration failure. It should be noted that, in the present disclosure, a description will be given of three configuration examples as examples of the configuration in which no potential difference occurs between two electrodes. A first configuration example is a configuration in which the driving voltage is simultaneously supplied to each of the two electrodes (a first embodiment to a third embodiment, and a fifth embodiment). A second configuration example is a configuration in which the driving voltage supplied to each of the two electrodes is simultaneously cut off (a fourth embodiment). A third configuration example is a configuration in which the potentials of the voltages supplied to each of the two electrodes are controlled to be the same potential (sixth embodiment). Hereinafter, the details of the present disclosure will be described.

### First Embodiment

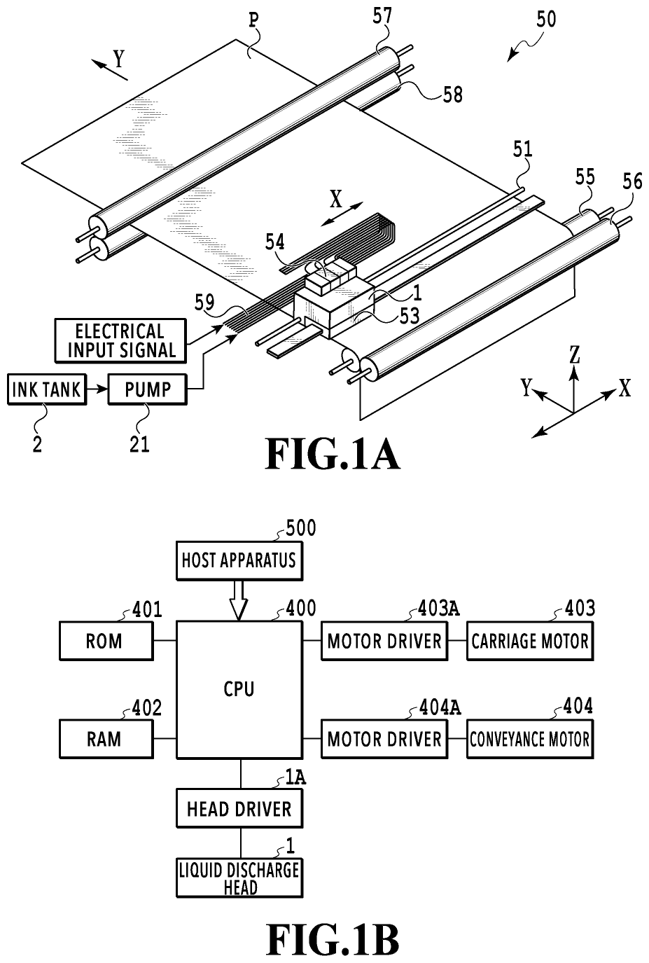

FIG. 1A and FIG. 1B are schematic configuration diagrams of a liquid discharge apparatus 50 of the present disclosure according to the first embodiment. FIG. 1A is a schematic perspective view of the liquid discharge apparatus 50. FIG. 1B is a block diagram of a control system of the liquid discharge apparatus 50. The liquid discharge apparatus 50 includes a liquid discharge head 1 and conveyance rollers 55, 56, 57, and 58. The liquid discharge head 1 is capable of scanning in a direction X that intersects with a conveyance direction Y of a discharge receiving medium P. In an example of FIG. 1A, the liquid discharge head 1 is mounted on a carriage 53. The carriage 53 reciprocates in a main scanning direction (also referred to as the direction X) along a guide shaft 51. The conveyance rollers 55, 56, 57, and 58 convey the discharge receiving medium P in a sub-scanning direction (also referred to as the conveyance direction Y) that intersects with (that is orthogonal to in the present embodiment) the main scanning direction. That is, the liquid discharge apparatus 50 discharges liquid from the liquid discharge head 1 to the discharge receiving medium P that is being conveyed in the conveyance direction Y while scanning the liquid discharge head 1 in the direction X, thereby constituting a serial-type inkjet liquid discharge apparatus. It should be noted that application of the present disclosure is not limited to the serial-type inkjet liquid discharge apparatus. The present disclosure can also be applied to a page wide-type inkjet liquid discharge apparatus that discharges liquid to the discharge receiving medium P that is conveyed in the conveyance direction Y, by using a line head (page wide-type head) that is long in a page width direction of the discharge receiving medium P. In FIG. 1A, a direction Z indicates a vertical direction. That is, the direction Z is a direction that intersects with (is orthogonal to in the present embodiment) an XY plane specified by the direction X and the conveyance direction Y. It should be noted that, in the following description, it is assumed that the direction X, the conveyance direction Y, and the direction Z are used in the same sense as described above.

The liquid discharge head 1 can discharge four types of inks, that is, black (K), cyan (C), magenta (M), and yellow (Y). The liquid discharge head 1 can discharge full color images with these four types of inks. It should be noted that the inks that can be discharged from the liquid discharge head 1 is not limited to the above-described four types of ink. For example, the present disclosure can also be applied to the liquid discharge head 1 for discharging other types of inks such as a spot color ink. That is, the types and number of inks discharged from the liquid discharge head 1 are not limited. In addition, a cap member for covering a face surface of the liquid discharge head 1 may be arranged at a position deviated from a conveyance path of the discharge receiving medium P. The cap member relatively moves to the position at which the face surface of the liquid discharge head 1 is covered, in a case where a recording operation is not performed. According to this operation, it is possible to prevent a discharge orifice for the liquid of the liquid discharge head 1 from being dried, or to perform a suctioning operation for filling or recovery.

In the example of FIG. 1A, an ink circulation unit 54 is mounted to the liquid discharge head 1. A guide 59 housing four ink supply tubes (liquid communication path) is attached to the ink circulation unit 54. The guide 59 houses electric wiring lines and air pipes that are required for discharging the liquid, in addition to the ink supply tubes. In addition, an ink tank 2 and a pump 21 are provided on a body (not illustrated) side of the liquid discharge apparatus 50. The ink tank 2 stores the inks. The inks stored in the ink tank 2 are supplied to the ink circulation unit 54 via the four ink supply tubes by the driving force of the pump 21. The liquid discharge head 1 may be provided integrally with the ink circulation unit 54, and may be configured to be detachable from or attachable to the carriage 53. Alternatively, the ink circulation unit 54 may be provided integrally with the carriage 53, and only the ink circulation unit 54 may be configured to be detachable or attachable. It should be noted that, in the following description, an example will be described in which the liquid discharge head 1 includes the ink circulation unit 54.

A CPU 400 in FIG. 1B performs various kinds of control of the liquid discharge apparatus 50. A program such as a processing procedure is stored in a ROM 401. The CPU 400 obtains the program such as the processing procedure from the ROM 401. The CPU 400 controls the liquid discharge apparatus 50 based on the obtained program. The CPU 400 uses a RAM 402 as a work area for executing the program obtained from the ROM 401. The CPU 400 obtains image data from a host apparatus 500 provided outside the liquid discharge apparatus 50. The CPU 400 controls a head driver 1A based on the obtained image data. The head driver 1A controls discharging of the liquid by the liquid discharge head 1. In addition, the CPU 400 controls a motor driver 403A. The motor driver 403A controls a carriage motor 403. The carriage motor 403 moves the carriage 53 along the direction X. The CPU 400 controls a motor driver 404A. The motor driver 404A controls a conveyance motor 404. The conveyance motor 404 controls the conveyance rollers 55, 56, 57, and 58. The conveyance rollers 55, 56, 57, and 58 convey the discharge receiving medium P along the conveyance direction Y.

### Liquid Discharge Head 1

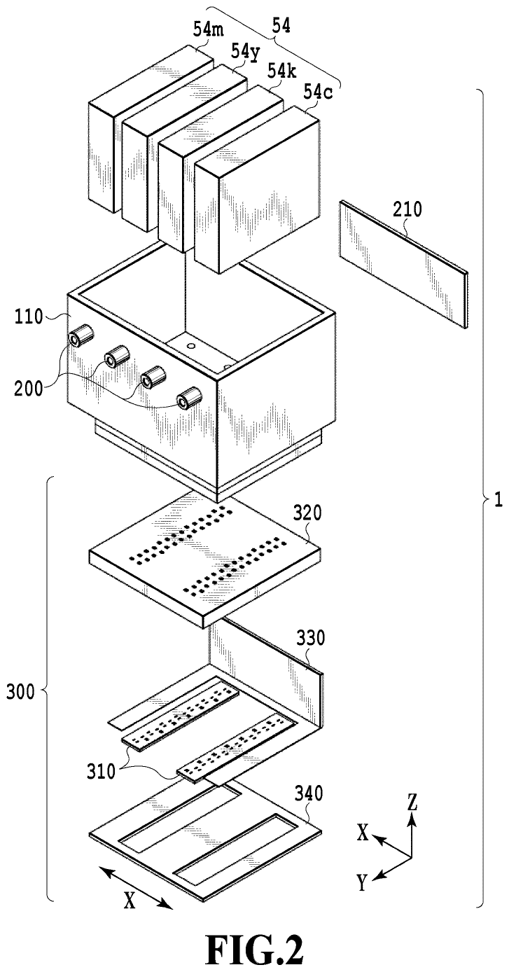

FIG. 2 is an exploded perspective view of the liquid discharge head 1 in FIG. 1A and FIG. 1B according to the first embodiment. The liquid discharge head 1 includes a channel member 110, the ink circulation unit 54, and a discharge unit 300. At least a part of the ink circulation unit 54 is accommodated in the channel member 110, and is connected to the channel member 110. The discharge unit 300 is provided at a bottom portion of the channel member 110, and is connected to the channel member 110. Specifically, the ink circulation unit 54 is constituted by ink circulation units 54m, 54y, 54k, and 54c corresponding to the respective inks. In cases where each of the ink circulation units 54m, 54y, 54k, and 54c is not particularly distinguished from one another, they are referred to as the ink circulation unit 54. Each ink circulation unit 54 is accommodated in and connected to the channel member 110. Each ink circulation unit 54 and the channel member 110 may be connected by screw fastening, after sandwiching a sealing member between each ink circulation unit 54 and the channel member 110. Alternatively, each ink circulation unit 54 and the channel member 110 may be connected by welding. The channel member 110 includes a surface in which four joints 200 connected to the four ink supply tubes corresponding to the four types of inks, respectively, are provided. That is, an individual ink collection channel is provided for each type of ink. Specifically, the ink circulation units 54m, 54y, 54k, and 54c are connected to the ink supply tubes corresponding to the inks from the body side of the liquid discharge apparatus 50 via the joints 200, respectively. The inks supplied from the corresponding ink supply tubes are supplied to the ink circulation units 54 via the joints 200, respectively. The inks supplied to the respective ink circulation units 54 are supplied to the discharge unit 300 via the channel member 110.

The discharge unit 300 includes discharge element substrates 310, a support member 320, an electric wiring substrate 330, and a cover member 340. The discharge element substrates 310 and the electric wiring substrate 330 are bonded and fixed to the support member 320. The cover member 340 is adjoined so as to cover a surface of the electric wiring substrate 330. The portions of the cover member 340 corresponding to the discharge element substrates 310 are opened. Each of the discharge element substrates 310 includes actuators that discharges the inks. Therefore, the discharge element substrates 310 can discharge liquid onto the discharge receiving medium P that passes below the liquid discharge head 1. It should be noted that the discharge unit 300 and the channel member 110 are bonded by using an adhesive agent. Alternatively, the discharge unit 300 and the channel member 110 may be fixed by screw fastening with a sealing member sandwiched between them.

The discharge element substrates 310 and the electric wiring substrate 330 are electrically connected by wire bonding. The electric wiring substrate 330 sends various electric signals to the discharge element substrates 310. Each of the discharge element substrates 310 discharges the liquid by the driving voltage supplied from the head driver 1A in response to the various electric signals from the electric wiring substrate 330. The details of the various electric signals will be described later. It should be noted that the discharge element substrates 310 and the electric wiring substrate 330 may be electrically connected by flying lead bonding or the like.

A contact surface is provided on the side opposite to the surface of the channel members 110 in which the joints 200 are provided. A head board 210 is connected to the contact surface. The head board 210 receives the electric signals from the body of the liquid discharge apparatus 50. The head board 210 and the electric wiring substrate 330 are electrically connected. The electric signals received by the head board 210 is sent to the discharge element substrates 310 via the electric wiring substrate 330. It should be noted that the head board 210 and the channel member 110 may be fixed by caulking, may be fixed by an adhesive agent, or may be fixed by a two-sided adhesive tape. In addition, the head board 210 and a carriage board 220 may be electrically connected by being fixed by ACF (anisotropic conductive film) pressure bonding. Alternatively, the head board 210 and the electric wiring substrate 330 may be electrically connected by wire bonding. Alternatively, the head board 210 and the electric wiring substrate 330 may be electrically connected by flying lead bonding.

### Ink Circulation Path

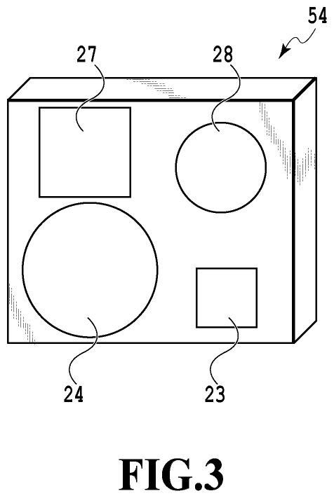

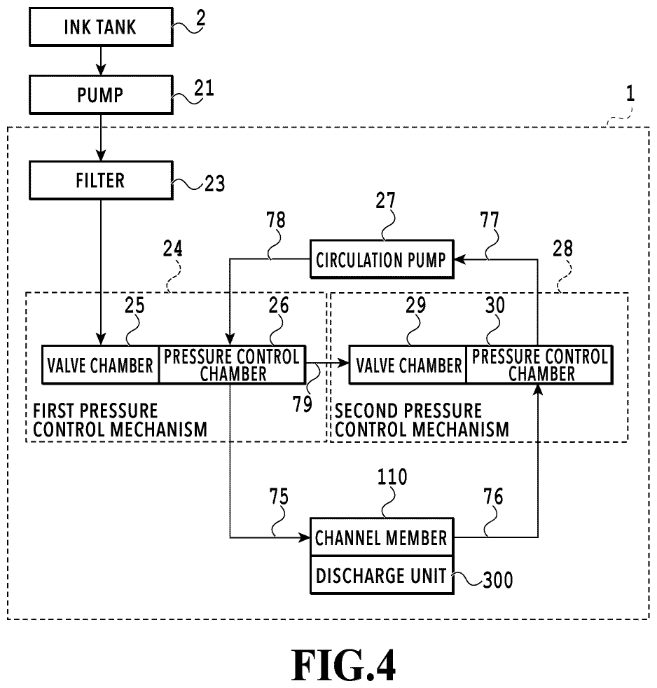

FIG. 3 is a schematic configuration diagram of the ink circulation unit 54 in FIG. 2 according to the first embodiment. One ink circulation unit 54 is arranged per color. The ink circulation unit 54 includes a first pressure control mechanism 24, a second pressure control mechanism 28, a filter 23, and a circulation pump 27. FIG. 4 is a schematic diagram of an ink circulation path that circulates the liquid by the circulation pump 27 in FIG. 3 according to the first embodiment. The ink circulation path in FIG. 4 is for one color. The liquid discharge head 1 is provided with the ink circulation path in FIG. 4 for each ink. The ink tank 2 and the pump 21 are provided on the body side of the liquid discharge apparatus 50. The first pressure control mechanism 24 includes a valve chamber 25 and a pressure control chamber 26. The valve chamber 25 and the pressure control chamber 26 communicate with each other via a valve that is not illustrated. The second pressure control mechanism 28 includes a valve chamber 29 and a pressure control chamber 30. The valve chamber 29 and the pressure control chamber 30 communicate with each other via a valve that is not illustrated. The circulation pump 27 and the pressure control chamber 26 are connected via a pump outlet channel 78. The pressure control chamber 26 and the channel member 110 are connected via a supply channel 75. A part of the channel member 110 may constitute the supply channel 75. The channel member 110 and the pressure control chamber 30 are connected via a collecting channel 76. A part of the channel member 110 may constitute the collecting channel 76. The pressure control chamber 30 and the circulation pump 27 are connected via a pump inlet channel 77. That is, the ink circulation path consisting of the pressure control chamber 26, the supply channel 75, the channel member 110, the collecting channel 76, the pressure control chamber 30, the pump inlet channel 77, the circulation pump 27, and the pump outlet channel 78 is formed. The inks can circulate through the ink circulation path. Next, after describing the details of the circulation pump 27, the flow of the inks circulating through the ink circulation path will be described.

### Drive Mechanism of Circulation Pump 27

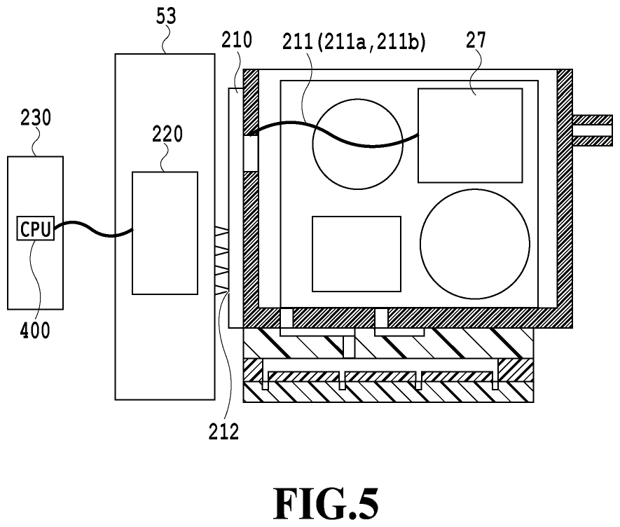

FIG. 5 is a diagram illustrating an example of wiring of the circulation pump 27 in FIG. 4 according to the first embodiment. A main PCB 230 is provided to the body of the liquid discharge apparatus 50. The CPU 400 is mounted to the main PCB 230. The carriage board 220 is provided to the carriage 53. The main PCB 230 and the carriage board 220 are connected via an FFC (flexible flat cable). A drive signal is sent to the carriage board 220 from the CPU 400 via the FFC. The carriage board 220 and the head board 210 are contact-connected via an electric connection portion 212. A pump control signal and a pump drive reference voltage are sent from the carriage board 220 to the head board 210 via the electric connection portion 212. The head board 210 and the circulation pump 27 are connected via a harness 211. The harness 211 is constituted by a cable assembly including first wiring 211a and second wiring 211b. A pump drive signal which is generated, based on the pump control signal and based on a pump drive voltage generated from the pump drive reference voltage is output to the circulation pump 27 via the harness 211. The circulation pump 27 is driven based on the pump drive signal, and the liquid is circulated.

### Configuration of Circulation Pump 27

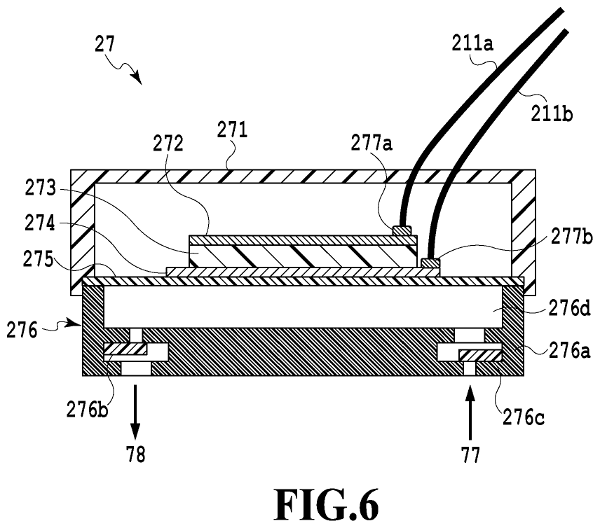

FIG. 6 is a cross-section schematic diagram of the circulation pump 27 in FIG. 5 according to the first embodiment. The first wiring 211a is connected to a first electrode 272 via an electric connection member 277a. The second wiring 211b is connected to a second electrode 274 via an electric connection member 277b. The electric connection members 277a and 277b are solder in the present embodiment, but are not particularly limited to this. An electrically conductive member such as a gold bump may be used for the electric connection members 277a and 277b. A piezoelectric element 273 is provided between the first electrode 272 and the second electrode 274. One surface of the piezoelectric element 273 is in contact with the first electrode 272. The other surface of the piezoelectric element 273 is in contact with the second electrode 274. One surface of the second electrode 274 is in contact with the piezoelectric element 273, and the other surface of the second electrode 274 is in contact with a vibrating plate 275. That is, a multilayer body in which the first electrode 272, the piezoelectric element 273, the second electrode 274, and the vibrating plate 275 are laminated in this order is constituted. A pump housing 271 is provided so as to cover the multilayer body. In addition, of two surfaces of the vibrating plate 275, the surface opposite to the surface on which the multilayer body is constituted is provided with a diaphragm unit 276. The diaphragm unit 276 includes a diaphragm unit housing 276a, a valve element 276b, and a valve element 276c. The diaphragm unit housing 276a is constituted by a concave housing. A concave edge of the diaphragm unit housing 276a and an edge of the vibrating plate 275 are fixed in contact with each other, thereby forming a pressure chamber 276d. The valve element 276b and the valve element 276c are provided in a bottom portion of the diaphragm unit housing 276a at positions spaced apart from each other by a fixed distance in a state where they can freely move and function as valves according to the outflow of the liquid from the pressure chamber 276d and the inflow of the liquid into the pressure chamber 276d. The pump outlet channel 78 in FIG. 4 is arranged at the position opposite the valve element 276b. The pump inlet channel 77 in FIG. 4 is arranged at the position opposite the valve element 276c. Next, the flow of the inks will be described with reference to FIG. 4.

### Flow of Inks

Refer to FIG. 4 again. The pump 21 in FIG. 4 pressurizes and supplies the inks stored in the ink tank 2 to the liquid discharge head 1. The filter 23 removes dust included in the inks pressurized by and supplied from the pump 21. The ink from which dust has been removed by the filter 23 is supplied to the valve chamber 25 of the first pressure control mechanism 24. In case where the inks supplied to the valve chamber 25 flows into the pressure control chamber 26, the pressure of the inks is controlled by the circulation pump 27. Next, the details of control of the pressure by the circulation pump 27 will be described with reference to FIG. 6.

By generating a potential difference in the piezoelectric element 273 in FIG. 6, the volume inside the pressure chamber 276d is changed, and the pressure fluctuation inside the pressure chamber 276d is generated. Since the pressure fluctuation inside the pressure chamber 276d causes the two valve elements 276b and 276c to move alternately to send the inks, the circulation pump 27 functions as a piezoelectric diaphragm pump. The circulation pump 27 is driven so as to send the inks with the pump inlet channel 77 being the downstream side and with the pump outlet channel 78 being the upstream side. Here, refer to FIG. 4 again. The inks the pressure of which has been controlled inside the pressure control chamber 26 is supplied to the supply channel 75 and a bypass channel 79 by the driving of the circulation pump 27 in FIG. 4. The supply channel 75 supplies the inks to the channel member 110. The channel member 110 supplies the inks supplied from the supply channel 75 to the discharge unit 300. The inks supplied to the discharge unit 300 is supplied to the discharge element substrates 310 inside the discharge unit 300. Each of the discharge element substrates 310 is provided with a plurality of discharge elements. The inks supplied to the discharge element substrates 310 pass through the discharge elements and are then discharged to the collecting channel 76. The discharge element includes an energy generating element, a pressure chamber, and a discharge orifice. The inks that have passed through the pressure chamber inside the discharge element and have been discharged to the collecting channel 76 is supplied to the pressure control chamber 30. In addition, the inks supplied to the valve chamber 29 via the bypass channel 79 are supplied to the pressure control chamber 30 that communicates with the valve chamber 29 via the valve that connects the valve chamber 29 and the pressure control chamber 30. Therefore, the inks are supplied to the pressure control chamber 30 from each of the collecting channel 76 and the bypass channel 79. The inks supplied to the pressure control chamber 30 are supplied to the circulation pump 27 via the pump inlet channel 77. The inks supplied to the circulation pump 27 are supplied to the pressure control chamber 26 via the pump outlet channel 78. In this way, the inks circulate through the discharge elements formed in the discharge element substrates 310, driven by the circulation pump 27. In this manner, the ink circulation path through which the inks are circulated is constituted. According to such a configuration, thickening of the inks in the discharge elements can be suppressed. The ink circulation path is not limited to the configuration that passes through the discharge elements. For example, as long as it is within a range that has the effect of suppressing thickening of the inks in the discharge elements, the ink circulation path may be configured so as to circulate the inks inside the discharge unit 300. Next, regarding the inflow and outflow of the inks, the following three use cases will be described with reference to FIG. 6.

### Use Case 1

A use case in which the inks flow into the pressure chamber 276d will be described. A case is assumed where a potential difference occurs in the direction from the second electrode 274 to the first electrode 272, and the piezoelectric element 273 and the vibrating plate 275 are displaced in a direction that expands the pressure chamber 276d. In the case of this assumption, the valve element 276c is opened, and inks flow into the pressure chamber 276d from the pump inlet channel 77.

### Use Case 2

A use case in which the inks flow out of the pressure chamber 276d will be described. A case is assumed where a potential difference occurs in the direction from the first electrode 272 to the second electrode 274, and the piezoelectric element 273 and the vibrating plate 275 are displaced in a direction that contracts the pressure chamber 276d. In the case of this assumption, the valve element 276b is opened, and the inks flow out into the pump outlet channel 78 from the pressure chamber 276d.

### Use Case 3

A description will be given of a use case in which there is neither inflow of the inks into the pressure chamber 276d nor outflow of the inks from the pressure chamber 276d. A case is assumed where no potential difference occurs between the first electrode 272 and the second electrode 274. In the case of this assumption, the piezoelectric element 273 and the vibrating plate 275 are not displaced in either the direction that expands the pressure chamber 276d or the direction that contracts the pressure chamber 276d. Therefore, the inflow and outflow of the inks into and from the diaphragm unit 276 do not occur.

That is, by periodically changing the potential difference between the first electrode 272 and the second electrode 274, the circulation pump 27 causes the inks to flow from the pump inlet channel 77, and causes the inks to flow out from the pump outlet channel 78. Next, a description will be given of a step of generating the drive signal for driving the circulation pump 27 based on the control signal and the reference voltage.

### Pump Driving Circuit in First Embodiment

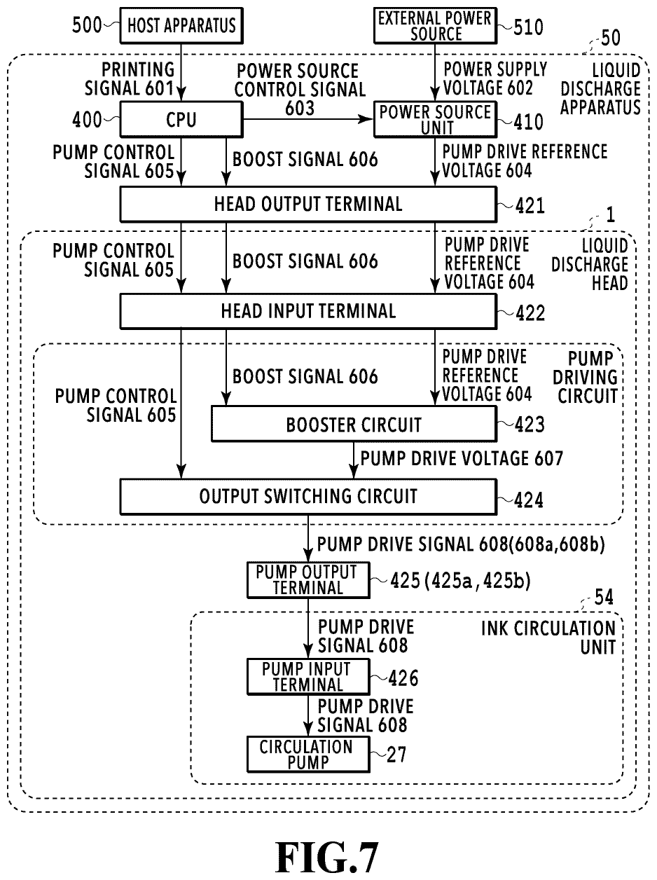

FIG. 7 is a diagram illustrating an example of a pump driving circuit that drives the circulation pump in FIG. 6 according to the first embodiment. The liquid discharge apparatus 50 in FIG. 7 includes the CPU 400, a power source unit 410, and a head output terminal 421 as the configuration included in the body of the liquid discharge apparatus 50 in FIG. 1. The liquid discharge head 1 includes a head input terminal 422, a booster circuit 423, and an output switching circuit 424, in addition to the ink circulation unit 54 described with reference to FIG. 1 to FIG. 3. The head output terminal 421 supplies various signals and various voltages to the head input terminal 422. Among the head input terminal 422, the booster circuit 423, and the output switching circuit 424, the booster circuit 423 and the output switching circuit 424 function as a pump driving circuit.

A printing signal 601 as image data is input to the CPU 400 of the liquid discharge apparatus 50 from the host apparatus 500. In the meanwhile, a power supply voltage 602 is supplied to the power source unit 410 from an external power source 510. The CPU 400 activates the power control signal 603 to the power source unit 410 by receiving the printing signal 601 from the host apparatus 500. It should be noted that, in the present embodiment, the power source control signal 603 is assumed to be high active. That is, it is assumed that when the power source control signal 603 is high, the power source unit 410 is set to operate. Specifically, when the signal potential of the power source control signal 603 transitions from 0 V to 3.3 V, the power source unit 410 outputs a pump drive reference voltage 604 to the head output terminal 421. In the present embodiment, the pump drive reference voltage 604 is assumed to be 5 V. The CPU 400 outputs a pump control signal 605 and a boost signal 606 to the head output terminal 421 by receiving the input of the printing signal 601 from the host apparatus 500.

### Pump Control Signal 605

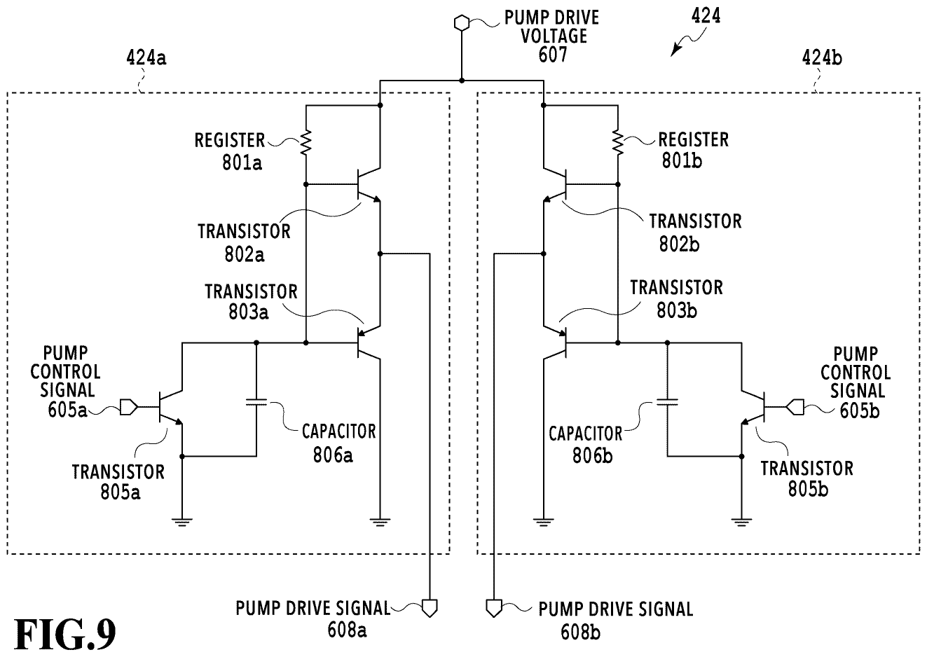

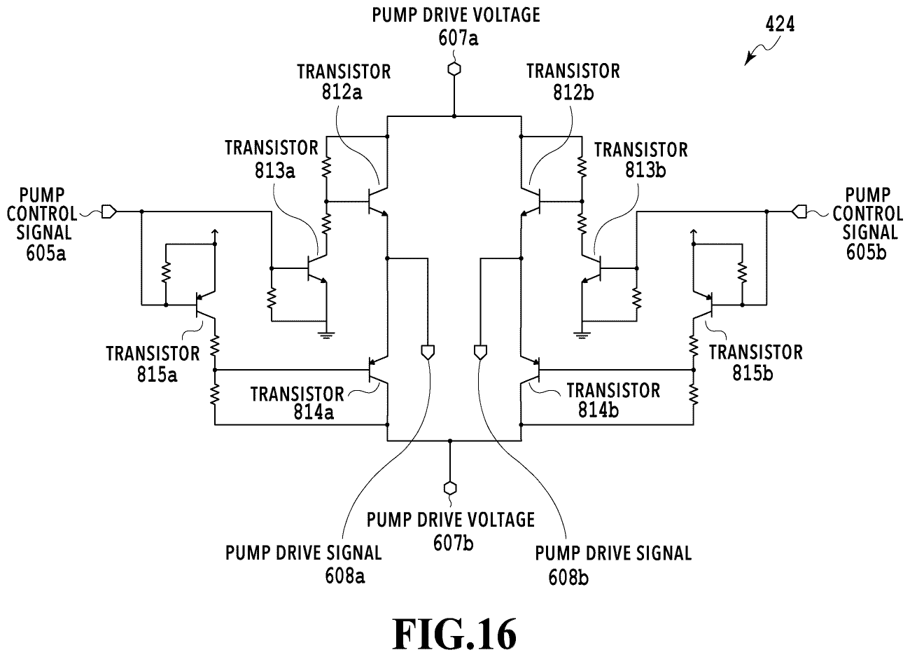

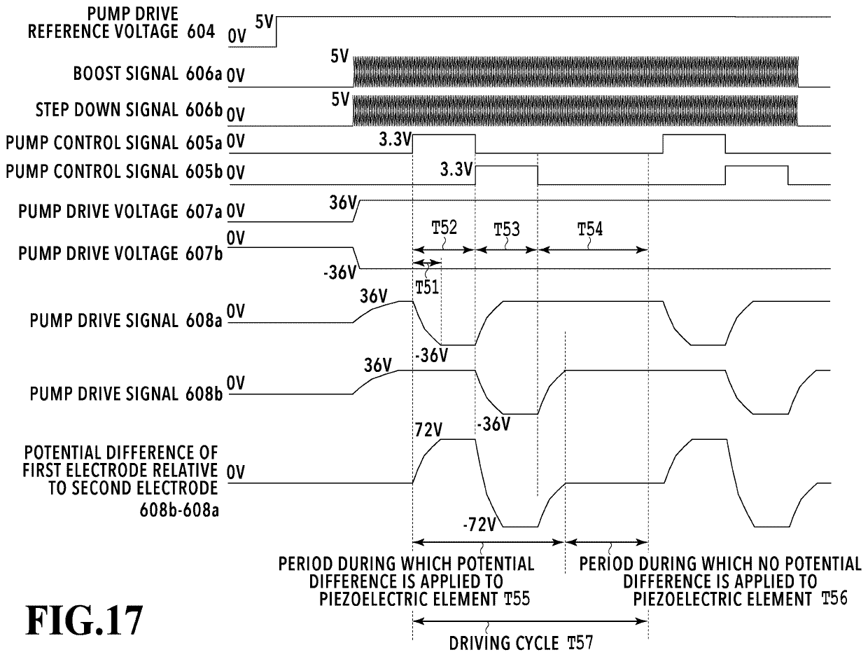

The pump control signal 605 includes a pump control signal 605a in FIG. 9 through FIG. 13, FIG. 16, FIG. 17 and a pump control signal 605b in FIG. 9 through FIG. 13, FIG. 16, FIG. 17. The pump control signal 605a and the pump control signal 605b correspond to the first electrode 272 and the second electrode 274, respectively. The pump control signals 605a and 605b are sent to the output switching circuit 424 via the head output terminal 421 and the head input terminal 422. When the signal potential of each of the pump control signals 605a and 605b transitions from 0 V to 3.3 V, each of the pump control signals 605a and 605b becomes active. That is, it is assumed that each of the pump control signals 605a and 605b is high active.

### Boost Signal 606

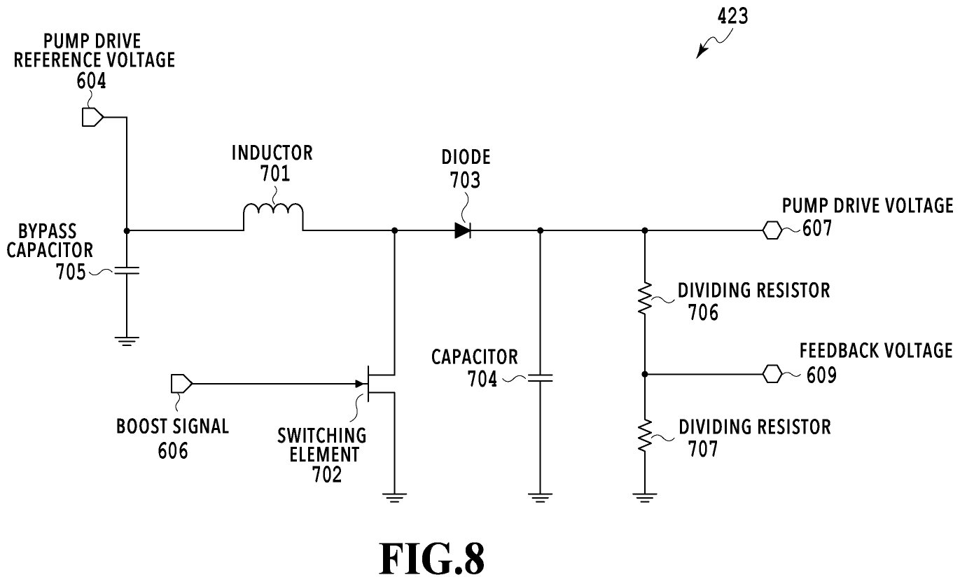

When the signal potential of the boost signal 606 transitions from 0 V to 5 V, which is the active potential, the booster circuit 423 is driven. Specifically, the pump drive reference voltage 604 output from the head input terminal 422 is input to a voltage input terminal of the booster circuit 423. The boost signal 606 output from the head input terminal 422 is input to a signal input terminal of the booster circuit 423. According to the boost signal 606, the booster circuit 423 converts the pump drive reference voltage 604 of 5 V to a voltage required for the piezoelectric element 273 provided to the circulation pump 27 to be sufficiently displaced. The booster circuit 423 converts the pump drive reference voltage 604 of 5 V to, for example, a voltage of 72 V. The booster circuit 423 outputs the voltage converted to 72 V to the output switching circuit 424 as a pump drive voltage 607. A specific circuit example of the booster circuit 423 will be described with reference to FIG. 8.

### Booster Circuit 423

FIG. 8 is a diagram illustrating an example of the booster circuit 423 in FIG. 7 according to the first embodiment. In an example of FIG. 8, the booster circuit 423 includes a bypass capacitor 705, an inductor 701, a switching element 702, a diode 703, a capacitor 704, a dividing resistor 706, and a dividing resistor 707. For example, a chip inductor is used for the inductor 701. For example, an n-channel FET is used for the switching element 702. In FIG. 8, the ground constitutes the potential that serves as the reference for circuit operation. The ground is constituted by, for example, the ground terminal as a frame ground or as a signal ground. Alternatively, the ground may be constituted by the ground terminal as a frame earth or as a signal earth.

### Connection Configuration of Booster Circuit 423

One terminal of the bypass capacitor 705 is connected to the ground terminal. The other terminal of the bypass capacitor 705 is connected to the voltage input terminal of the booster circuit 423. The pump drive reference voltage 604 is applied to the voltage input terminal of the booster circuit 423. In addition, one terminal of the inductor 701 is also connected to the input terminal of the booster circuit 423. The other terminal of the inductor 701 is connected to an anode of the diode 703, and a drain of the switching element 702. A source of the switching element 702 is connected to the ground terminal. When the boost signal 606 input from the signal input terminal of the booster circuit 423 is input to a gate of the switching element 702, the drain and the source of the switching element 702 are brought into a conductive state. One terminal of the capacitor 704 is connected to a cathode of the diode 703. The other terminal of the capacitor 704 is connected to the ground terminal. In addition, one terminal of the dividing resistor 706 and a first voltage output terminal of the booster circuit 423 are connected to the cathode of the diode 703. The first voltage output terminal can output the pump drive voltage 607. One terminal of the dividing resistor 707 is connected to the other terminal of the dividing resistor 706. The other terminal of the dividing resistor 707 is connected to the ground terminal. A second voltage output terminal of the booster circuit 423 is connected to a connection point between the dividing resistor 706 and the dividing resistor 707. The second voltage output terminal can output a feedback voltage 609.

### Operation of Booster Circuit 423

When the potential of the boost signal 606 transitions from the ground potential to the state of 5 V, which is the active potential, the switching element 702 is in a conductive state. Therefore, in a state where the pump drive reference voltage 604 is applied to the voltage input terminal of the booster circuit 423, a current flows from the voltage input terminal of the booster circuit 423 to the ground terminal via the inductor 701 and the switching element 702. Here, when the potential of the boost signal 606 transitions from the active potential to the ground potential, the switching element 702 is in a non-conductive state, and a back electromotive force is generated in the inductor 701. Therefore, the current generated by the back electromotive force of the inductor 701 flows to the capacitor 704 via the diode 703. Accordingly, charge flows into the capacitor 704. The charge that has flowed into and has been accumulated in the capacitor 704 cannot return to the anode side of the diode 703 due to the diode 703. Accordingly, since the conductive state and the non-conductive state of the switching element 702 are repeated by the boost signal 606, charge flows into and is accumulated in the capacitor 704. As a result, the pump drive voltage 607 is boosted to a voltage higher than the pump drive reference voltage 604. In the present embodiment, the pump drive voltage 607 is divided by the dividing resistor 706 and the dividing resistor 707. With this voltage division, the feedback voltage 609 is output from the second voltage output terminal. The feedback voltage 609 is output to the CPU 400. Based on the feedback voltage 609, the CPU 400 controls the ON/OFF duty ratio of the boost signal 606 so that the potential of the pump drive voltage 607 output from the first voltage output terminal can become 72 V. It should be noted that the booster circuit 423 is not limited to the example in FIG. 8. For example, the booster circuit 423 may be constituted by a charge pump circuit. Alternatively, the booster circuit 423 may be constituted by a power supply unit that converts an alternating current input from the outside to a direct current of 72 V.

### Output Switching Circuit 424

Refer to FIG. 7 again. The output switching circuit 424 outputs the pump drive voltage 607 to the pump output terminal 425 as a pump drive signal 608, according to the pump control signal 605 input from the head input terminal 422. The pump drive signal 608 includes a pump drive signal 608a and a pump drive signal 608b. The details of the output switching circuit 424 will be described with reference to FIG. 9.

FIG. 9 is a diagram illustrating an example of the output switching circuit 424 in FIG. 7 according to the first embodiment. The output switching circuit 424 includes a first voltage control circuit 424a and a second voltage control circuit 424b. The first voltage control circuit 424a and the second voltage control circuit 424b are provided in parallel. In a state where the pump drive voltage 607 is input, the first voltage control circuit 424a outputs the pump drive signal 608a based on the input of the pump control signal 605a. The first voltage control circuit 424a includes an a signal system corresponding to the first electrode 272. The a signal system controls the output of the pump drive signal 608a to the first electrode 272 via the first wiring 211a. Therefore, the a signal system can control the voltage applied to the first electrode 272. In a state where the pump drive voltage 607 is input, the second voltage control circuit 424b outputs the pump drive signal 608b based on the input of the pump control signal 605b. The second voltage control circuit 424b includes a b signal system corresponding to the second electrode 274. The b signal system controls the output of the pump drive signal 608b to the second electrode 274 via the second wiring 211b. Therefore, the b signal system can control the voltage applied to the second electrode 274.

### Connection Configuration of First Voltage Control Circuit 424a

The first voltage control circuit 424a includes a register 801a, a transistor 802a, a transistor 803a, a transistor 805a, and a capacitor 806a. The transistor 802a is constituted by an NPN transistor. The transistor 803a is constituted by a PNP transistor. The transistor 805a is constituted by an NPN transistor. One terminal of the register 801a is connected to the collector of the transistor 802a. The collector of the transistor 802a is connected to a voltage input terminal of the pump drive voltage 607. The other terminal of the register 801a is connected to the base of the transistor 802a. The base of the transistor 803a, one terminal of the capacitor 806a, and the collector of the transistor 805a are connected to the base of the transistor 802a. The emitter of the transistor 803a is connected to the emitter of the transistor 802a. The pump drive signal 608a can be output from a signal output terminal provided between the emitter of the transistor 803a and the emitter of the transistor 802a. The pump control signal 605a is input to the base of the transistor 805a. The emitter of the transistor 805a and the other terminal of the capacitor 806a are connected to the ground terminal. It should be noted that the switching elements of the first voltage control circuit 424a are not limited to the transistors 802a, 803a, and 805a. The switching elements of the first voltage control circuit 424a may be FETs.

### Operation of First Voltage Control Circuit 424a

### Potential of Pump Control Signal 605a: Ground Potential

In a state where the potential of the pump control signal 605a is the ground potential, the emitter and collector of the transistor 805a is in a non-conductive state. Therefore, the transistor 805a is open. When the transistor 805a is open, the pump drive voltage 607 is applied to the base of the transistor 802a and the base of the transistor 803a. At this time, when the potential of the pump drive signal 608a is the ground potential, the potential of the emitter of the transistor 802a becomes the ground potential. Therefore, the potential of the emitter of the transistor 802a becomes lower than the potential of the base of the transistor 802a. Accordingly, a base current flows to the output destination of the pump drive signal 608a from the base of the transistor 802a. Therefore, the transistor 802a becomes active, and the pump drive voltage 607 is output as the pump drive signal 608a. In this case, the output voltage is 72 V. On the other hand, the potential of the emitter of the transistor 803a and the potential of the base of the transistor 803a become the same potential. Therefore, the transistor 803a is open. From the above, in a state where the potential of the pump control signal 605a is the ground potential, the potential of the pump drive signal 608a becomes the potential of the pump drive voltage 607.

### Potential of Pump Control Signal 605a: Active Potential

In a state where the potential of the pump control signal 605a is the active potential, a base current flows to the emitter of the transistor 805a from the base of the transistor 805a. Therefore, the transistor 805a becomes active, and the base of the transistor 802a and the base of the transistor 803a are connected to the ground terminal. At this time, when the potential of the pump drive signal 608a is 72 V, a base current flows to the base of the transistor 803a from the emitter of the transistor 803a. Therefore, the transistor 803a becomes active. When the transistor 803a becomes active, the emitter of the transistor 803a and the collector of the transistor 803a are in a conductive state, and the collector of the transistor 803a is connected to the ground terminal. Therefore, the ground terminal is connected between the emitter of the transistor 802a and the emitter of the transistor 803a. Accordingly, the potential of the pump drive signal 608a becomes the ground potential. In the meanwhile, since the potential of the base of the transistor 802a and the potential of the emitter of the transistor 802a become the same potential, the transistor 802a is open. From the above, in a state where the potential of the pump control signal 605a is the active potential, the potential of the pump drive signal 608a becomes the ground potential.

### Connection Configuration of Second Voltage Control Circuit 424b

The second voltage control circuit 424b includes a register 801b, a transistor 802b, a transistor 803b, a transistor 805b, and a capacitor 806b. The transistor 802b is constituted by an NPN transistor. The transistor 803b is constituted by a PNP transistor. The transistor 805b is constituted by an NPN transistor. One terminal of the register 801b is connected to the collector of the transistor 802b. The collector of the transistor 802b is connected to the voltage input terminal of the pump drive voltage 607. The other terminal of the register 801b is connected to the base of the transistor 802b. The base of the transistor 803b, one terminal of the capacitor 806b, and the collector of the transistor 805b are connected to the base of the transistor 802b. The emitter of the transistor 803b is connected to the emitter of the transistor 802b. The pump drive signal 608b can be output from a signal output terminal provided between the emitter of the transistor 803b and the emitter of the transistor 802b. The pump control signal 605b is input to the base of the transistor 805b. The emitter of the transistor 805b and the other terminal of the capacitor 806b are connected to the ground terminal. It should be noted that the switching elements of the second voltage control circuit 424b are not limited to the transistors 802b, 803b, and 805b. The switching elements of the second voltage control circuit 424b may be FETs.

### Operation of Second Voltage Control Circuit 424b

### Potential of Pump Control Signal 605b: Ground Potential

In a state where the potential of the pump control signal 605b is the ground potential, the emitter and collector of the transistor 805b are in a non-conductive state. Therefore, the transistor 805b is open. When the transistor 805b is open, the pump drive voltage 607 is applied to the base of the transistor 802b and the base of the transistor 803b. At this time, when the potential of the pump drive signal 608b is the ground potential, the potential of the emitter of the transistor 802b becomes the ground potential. Therefore, the potential of the emitter of the transistor 802b becomes lower than the potential of the base of the transistor 802b. Accordingly, a base current flows to the output destination of the pump drive signal 608b from the base of the transistor 802b. Therefore, the transistor 802b becomes active, and the pump drive voltage 607 is output as the pump drive signal 608b. In this case, the output voltage is 72 V. In the meanwhile, the potential of the emitter of the transistor 803b and the potential of the base of the transistor 803b become the same potential. Therefore, the transistor 803b is open. From the above, in a state where the potential of the pump control signal 605b is the ground potential, the potential of the pump drive signal 608b becomes the potential of the pump drive voltage 607.

### Potential of Pump Control Signal 605b: Active Potential

In a state where the potential of the pump control signal 605b is the active potential, a base current flows to the emitter of the transistor 805b from the base of the transistor 805b. Therefore, the transistor 805b becomes active, and the base of the transistor 802b and the base of the transistor 803b are connected to the ground terminal. At this time, when the potential of the pump drive signal 608b is 72 V, a base current flows to the base of the transistor 803b from the emitter of the transistor 803b. Therefore, the transistor 803b becomes active. When the transistor 803b becomes active, the emitter of the transistor 803b and the collector of the transistor 803b are in a conductive state, and the collector of the transistor 803b is connected to the ground terminal. Therefore, the ground terminal is connected between the emitter of the transistor 802b and the emitter of the transistor 803b. Accordingly, the potential of the pump drive signal 608b becomes the ground potential. In the meanwhile, since the potential of the base of the transistor 802b and the potential of the emitter of the transistor 802b become the same potential, the transistor 802b is open. From the above, in a state where the potential of the pump control signal 605b is the active potential, the potential of the pump drive signal 608b becomes the ground potential.

### Pump Output Terminal 425

Refer to FIG. 7 again. The pump output terminal 425 is constituted by a pump output terminal 425a and a pump output terminal 425b corresponding to the first electrode 272 and the second electrode 274, respectively. The pump output terminal 425 is provided to the head board 210. Of the pump drive signals 608a and 608b, the pump drive signal 608a is output to the pump output terminal 425a. Of the pump drive signals 608a and 608b, the pump drive signal 608b is output to the pump output terminal 425b. The potentials of the pump drive signals 608a and 608b transition between 0 V and 72 V. 72 V is set as the pump drive voltage for the circulation pump 27. The pump drive signals 608a and 608b output from the pump output terminals 425a and 425b, respectively, are sent to the ink circulation unit 54.

### Ink Circulation Unit 54

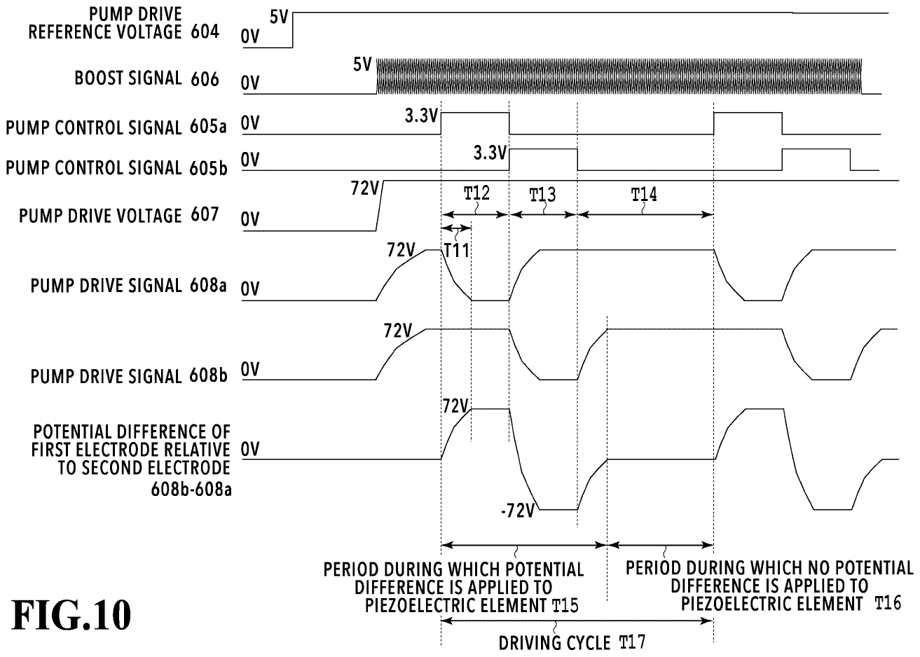

The ink circulation unit 54 includes a pump input terminal 426 and the circulation pump 27 as the configurations relevant to the pump drive signals 608a and 608b. The pump drive signals 608a and 608b sent from the pump output terminals 425a and 425b, respectively, are input to the pump input terminal 426. The pump input terminal 426 outputs each of the pump drive signals 608a and 608b to the circulation pump 27. The circulation pump 27 is driven according to each of the pump drive signals 608a and 608b output from the pump input terminal 426. Next, the driving of the circulation pump 27 will be described with reference to FIG. 10.

### Driving of Circulation Pump 27

FIG. 10 is a diagram for describing a timing chart of the control signal that controls the pump driving circuit according to the first embodiment. First, the potential of the pump drive reference voltage 604 transitions from 0 V to 5 V. Accordingly, the pump drive reference voltage 604 is applied to the booster circuit 423. Next, the potential of the boost signal 606 repeatedly transitions from 0 V to 5 V according to a predetermined rule. For example, the potential of the boost signal 606 repeatedly becomes 0 V and 5 V based on a predetermined duty ratio. Accordingly, the potential of the pump drive voltage 607 output from the booster circuit 423 is boosted to 72 V from 0 V. The boosted pump drive voltage 607 is applied to the output switching circuit 424. In the output switching circuit 424, with application of the pump drive voltage 607, the potential of each of the pump drive signals 608a and 608b is increased to 72 V, and becomes the same potential as the potential of the pump drive voltage 607.

### Period T12

Next, the potential of the pump control signal 605a transitions from 0 V to 3.3 V. When the potential of the pump control signal 605a is 3.3 V, the potential of the pump control signal 605b is 0 V. After the potential of the pump control signal 605a transitions to 3.3 V, the potential of the pump control signal 605a is maintained at 3.3 V during a period T12. In the meanwhile, since the potential of the pump control signal 605a transitions to 3.3 V, the potential of the pump drive signal 608a is decreased from 72 V to 0 V during a transition time period T11. The transition time period T11 mainly changes based on the capability of the booster circuit 423 and the capacity of the piezoelectric element 273. The higher the capability of the booster circuit 423 becomes, the longer the transition time period T11 becomes. The larger the capacity of the piezoelectric element 273 becomes, the longer the transition time period T11 becomes. In the present embodiment, it is assumed that the transition time period T11=12 ms. In addition, in the present embodiment, it is assumed that the period T12=16 ms. While the potential of the pump drive signal 608a is being decreased, since the potential of the pump control signal 605b is maintained at 0 V, the potential of the pump drive signal 608b is maintained at 72 V. After reaching 0 V, the potential of the pump drive signal 608a remains at 0 V during the period T12 during which the pump control signal 605a continues to be maintained at 3.3 V. Therefore, in the period T12, there is a period during which the potential difference between the potential of the pump drive signal 608a and the potential of the pump drive signal 608b becomes 72 V. In this period, the potential difference between the second electrode 274 and the first electrode 272 is 72 V. Due to this potential difference, the volume of the piezoelectric element 273 is displaced, and the inks flow into the pressure chamber 276d from the pump inlet channel 77.

### Period T13

Next, the potential of the pump control signal 605a transitions to 0 V, and simultaneously, the potential of the pump control signal 605b transitions from 0 V to 3.3 V. After the potential of the pump control signal 605b transitions to 3.3 V, the potential of the pump control signal 605b is maintained at 3.3 V during a period T13. In the meanwhile, since the potential of the pump control signal 605b transitions to 3.3 V, the potential of the pump drive signal 608b is decreased from 72 V to 0 V. After reaching 0 V, the potential of the pump drive signal 608b remains at 0 V during the period T13 during which the pump control signal 605b continues to be maintained at 3.3 V. In addition, in the present embodiment, it is assumed that the period T13=16 ms as in the period T12. Since the potential of the pump control signal 605a is maintained at 0 V while the potential of the pump drive signal 608b is being decreased, the potential of the pump drive signal 608a transitions from 0 V to 72 V. After reaching 72 V, the potential of the pump drive signal 608a is maintained at 72 V while the potential of the pump control signal 605a is maintained at 0 V. Therefore, in the period T13, there is a period during which the potential difference between the potential of the pump drive signal 608a and the potential of the pump drive signal 608b becomes −72 V. In this period, the potential difference between the second electrode 274 and the first electrode 272 is-72 V. Due to this potential difference, the volume of the piezoelectric element 273 is displaced, and the inks flow out from the pressure chamber 276d to the pump outlet channel 78.

### Period T14; Period T15; Period T16; Driving Cycle T17

After the period T13 has elapsed, the potential of the pump control signal 605b transitions from 3.3 V to 0 V. At the same time the potential of the pump control signal 605b transitions to 0 V, the potential of the pump drive signal 608b transitions from 0 V to 72 V. After the potential of the pump drive signal 608b reaches 72 V, since the potential of the pump control signal 605b remains at 0 V, the potential of the pump drive signal 608b is maintained at 72 V. In the meanwhile, the potential of the pump control signal 605a remains at 0 V. Therefore, the potential of the pump drive signal 608a continues to be maintained at 72 V. As a result, no potential difference occurs between the first electrode 272 and the second electrode 274. Accordingly, the displacement in the volume of the piezoelectric element 273 is eliminated. The inks flow into the pressure chamber 276d from the pump inlet channel 77 by the amount corresponding to the elimination of the displacement of the shape of the piezoelectric element 273. At the same time the period T13 ends, a period T14 is started, and while the period T14 continues, the potential of each of the pump control signal 605a and the pump control signal 605b is maintained at 0 V. In the present embodiment, the period T14=32 ms. After the period T14 has elapsed, the potential of the pump control signal 605a transitions to 3.3 V again during the period T12. That is, the control in which the periods T12, T13, and T14 form one driving cycle T17 is repeatedly performed. As described above, the delivery capability of the circulation pump 27 correlates with the volume displacement of the pressure chamber 276d and the number of deliveries. That is, the delivery capability of the circulation pump 27 correlates with the potential difference that is applied to the piezoelectric element 273 and the driving cycle T17. According to the present disclosure, a period T16 during which no potential difference occurs in the piezoelectric element 273 is provided between a period T15 during which a potential difference occurs in the piezoelectric element 273 and the next driving cycle T17. Accordingly, while not being involved in the ink delivery by the circulation pump 27, the progression of migration failure of the piezoelectric element 273 can be suppressed. In other words, one driving cycle T17 includes the period T15 during which a potential difference occurs in the piezoelectric element 273, and the period T16 during which no potential difference occurs in the piezoelectric element 273.

It should be noted that in order to sufficiently obtain the driving capability of the circulation pump 27, that is, the displacement in the volume of the piezoelectric element 273, it is desirable that the period T12 is equal to or more than the transition time period T11. However, when the driving cycle T17 has a long period that is occupied by the period T12 under predetermined conditions, the duration of the period T15 becomes long, and the duration of the period T16 becomes short. When the duration of the period T16 becomes short, the period during which migration failure is suppressed becomes short. Therefore, it is desirable that the period T12 is, for example, equal to or less than at least twice the transition time period T11. In addition, when the period T12 and the transition time period T11 are made equal to each other, it is possible to obtain a higher effect of achieving both the driving capability of the circulation pump 27 and the reliability of the piezoelectric element 273.

In addition, it is preferable that an electrical wiring path from the booster circuit 423 to the circulation pump 27 is provided at a location that is difficult for a user to touch. For example, in the head board 210 in FIG. 2 and FIG. 5, it is preferable that the booster circuit 423 is provided on the channel member 110 side. With such an arrangement configuration, the electrical wiring path from the booster circuit 423 to the circulation pump 27 is covered by the channel member 110. In addition, in FIG. 5, the carriage board 220 and the head board 210 may be integrated. Alternatively, the carriage board 220 and the head board 210 may be configured so as not to be detachable by a user. When the carriage board 220 and the head board 210 are configured so as not to be detachable by a user, the booster circuit 423 may be provided on the carriage board 220.

### Effects of First Embodiment

From the above description, the liquid discharge apparatus 50 includes a piezoelectric unit, a drive-control unit, and a diaphragm unit. The piezoelectric unit includes the first electrode 272, the second electrode 274 facing the first electrode 272, and the piezoelectric element 273 arranged between the first electrode 272 and the second electrode 274. The drive-control unit controls, in a state where the driving voltage generating distortion in the piezoelectric unit is supplied to the first electrode 272 and the second electrode 274, the distortion generated in the piezoelectric unit in the driving cycle T17 including a first period (the period T12+the period T13) and a second period (the period T14). The first period (the period T12+the period T13) includes a period during which the driving voltage (the pump drive voltage 607) supplied to either one of the first electrode 272 and the second electrode 274 is cut off. In the meanwhile, the second period (the period T14) includes a period during which no potential difference occurs between the first electrode 272 and the second electrode 274, and for example, the second period (the period T14) includes a period during which the driving voltage (the pump drive voltage 607) is simultaneously supplied to each of the first electrode 272 and the second electrode 274. According to such a configuration, in the first period, since the driving voltage supplied to either one of the two electrodes is cut off, the potential difference between the potential of the driving voltage and the ground potential occurs between the two electrodes. Therefore, in the first period, it becomes possible to generate distortion in the piezoelectric pump. Therefore, the liquid circulating capability is maintained. In the meanwhile, in the second period, no potential difference occurs between the first electrode 272 and the second electrode 274. When no potential difference occurs between the first electrode 272 and the second electrode 274, it does not mean that a voltage is applied between the two electrodes. Therefore, in the second period, even when the piezoelectric pump is in a highly humid environment, the piezoelectric pump will not be under the condition that a voltage is applied. That is, the second period may include a period during which the driving voltage is simultaneously supplied to each of the first electrode 272 and the second electrode 274, as a period during which no potential difference occurs between the first electrode 272 and the second electrode 274. According to such a configuration, since the potential of the first electrode 272 and the potential of the second electrode 274 become the same potential, no potential difference occurs between the first electrode 272 and the second electrode 274. Therefore, migration failure can be suppressed. Accordingly, by controlling the distortion generated in the piezoelectric pump by the driving cycle including the first period and the second period, it is possible to achieve maintaining of the liquid circulating capability and suppression of migration failure.

In addition, the drive-control unit may include the first voltage control circuit 424a and the second voltage control circuit 424b. The first voltage control circuit 424a controls whether or not to cut off the driving voltage supplied to the first electrode 272. The second voltage control circuit 424b is provided electrically in parallel with the first voltage control circuit 424a, and controls whether or not to cut off the driving voltage supplied to the second electrode 274. According to such a configuration, a voltage of the same potential can be supplied to the first electrode 272 and the second electrode 274, while separately controlling the first electrode 272 and the second electrode 274.

In addition, the drive-control unit may cut off the driving voltage supplied to the second electrode 274 by the second voltage control circuit 424b, while the driving voltage is supplied to the first electrode 272. In addition, the drive-control unit may cut off the driving voltage supplied to the first electrode 272 by the first voltage control circuit 424a, while the driving voltage is supplied to the second electrode 274. According to such a configuration, it is possible to generate a potential difference between the first electrode 272 and the second electrode 274. Accordingly, the liquid circulating capability can be maintained.

In addition, the liquid discharge apparatus 50 may further include a booster unit that supplies the driving voltage (the pump drive voltage 607) boosted based on the drive reference voltage (the pump drive reference voltage 604) at the same potential to each of the first voltage control circuit 424a and the second voltage control circuit 424b. According to such a configuration, the pump drive reference voltage 604 at the same potential is supplied to each of the first voltage control circuit 424a and the second voltage control circuit 424b. Therefore, when there is no potential difference between the first voltage control circuit 424a and the second voltage control circuit 424b, it becomes possible to eliminate the potential difference in the voltage applied to the piezoelectric element 273, and the period T14 in FIG. 10 can be realized. It should be noted that the booster unit may be realized by the booster circuit 423, or may be realized by a DC-DC converter.

In addition, the first period may include a first cutoff period (the period T12) and a second cutoff period (the period T13). In the first cutoff period (the period T12), the driving voltage (the pump drive voltage 607) supplied to the first electrode 272 is cut off. In the second cutoff period (the period T13), the driving voltage (the pump drive voltage 607) supplied to the second electrode 274 is cut off. In addition, the drive-control unit may control the distortion generated in the piezoelectric unit in the order of the first cutoff period (the period T12), the second cutoff period (the period T13), and the second period (the period T14), as the driving cycle T17. According to such a configuration, it is possible to provide, in one driving cycle T17, the period for maintaining the liquid circulating capability and the period for suppressing migration failure.

In addition, the drive-control unit may start the second cutoff period (the period T13) simultaneously with the end of the first cutoff period (the period T12). According to such a configuration, it is possible to include, in the driving cycle T17, the period T15 during which a potential difference is applied to the piezoelectric element 273, and the period T16 during which no potential difference is applied to the piezoelectric element 273, and it is also possible for the period T16 to follow the period T15.

In addition, when the driving voltage (the pump drive voltage 607) supplied to the first electrode 272 is cut off, a time period longer than the time period for the potential of the driving voltage (the pump drive voltage 607) supplied to the first electrode 272 to reach zero potential may be set to the first cutoff period (the period T12). In addition, when the driving voltage (the pump drive voltage 607) supplied to the second electrode 274 is cut off, a time period longer than the time period for the potential of the driving voltage (the pump drive voltage 607) supplied to the second electrode 274 to reach zero potential may be set to the second cutoff period (the period T13). According to such a configuration, it becomes possible to allow a sufficient potential difference between the first electrode 272 and the second electrode 274.

### Second Embodiment

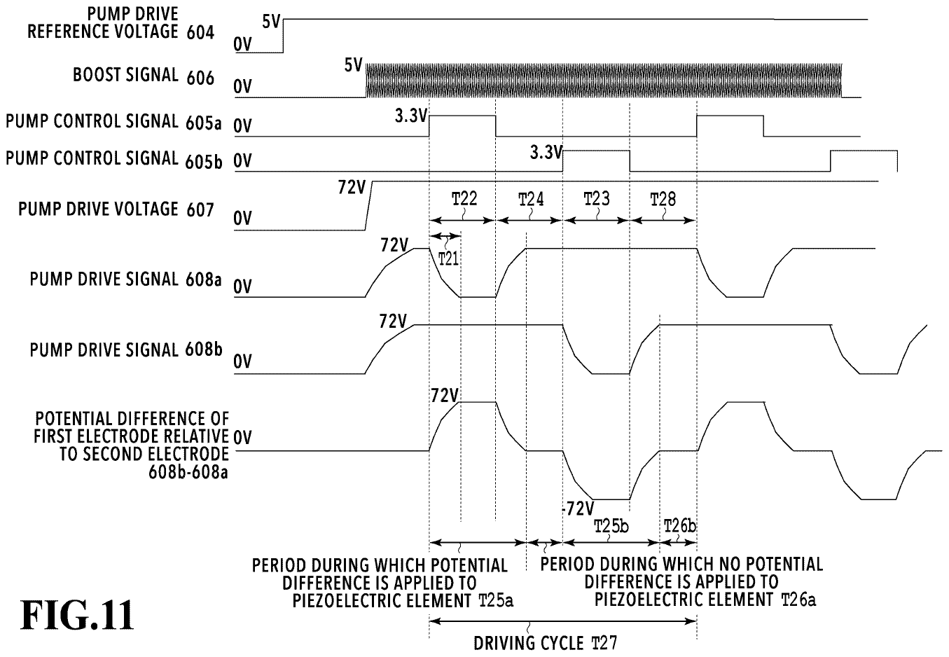

In a second embodiment, a description of configurations that are identical to those in the first embodiment will be omitted as appropriate. The second embodiment is different from the first embodiment in that when the pressure chamber 276d expands or contracts, the piezoelectric element 273 goes through a state of no displacement for a predetermined time period. FIG. 11 is a diagram for describing a timing chart of the control signal that controls the pump driving circuit according to the second embodiment. The timing chart in FIG. 11 is identical to the timing chart for the pump driving circuit in the first embodiment, until the potential of the pump drive voltage 607 is boosted to 72 V from 0 V. Hereinafter, the timing chart that is different from that in the first embodiment will be described.

### Period T22

After the potential of the pump drive voltage 607 transitions to 72 V, the potential of the pump control signal 605a transitions from 0 V to 3.3 V. After the potential of the pump control signal 605a transitions to 3.3 V, the potential of the pump control signal 605a is maintained at 3.3 V during a period T22. When the potential of the pump control signal 605a transitions to 3.3 V, the potential of the pump drive signal 608a transitions from 72 V to 0 V during a transition time period T21. In the present embodiment, it is assumed that the transition time period T21=12 ms and the period T22=16 ms. In the meanwhile, while the potential of the pump control signal 605a is maintained at 3.3 V, the potential of the pump control signal 605b is maintained at 0 V. Therefore, the potential of the pump drive signal 608b is maintained at 72 V. In the period T22, the potential difference between the potential of the pump drive signal 608b and the potential of the pump drive signal 608a becomes 72 V. That is, the potential difference between the second electrode 274 and the first electrode 272 becomes 72 V. Therefore, the volume of the piezoelectric element 273 is displaced, and the inks flow into the pressure chamber 276d from the pump inlet channel 77.

### Period T24

Next, the potential of the pump control signal 605a transitions from 3.3 V to 0 V. Therefore, the potential of the pump drive signal 608a transitions from 0 V to 72 V. After the potential of the pump drive signal 608a transitions to 72 V, the potential of the pump drive signal 608b is maintained at 72 V during a period T24. Therefore, no potential difference occurs between the second electrode 274 and the first electrode 272. Accordingly, the displacement in the volume of the piezoelectric element 273 is eliminated. The inks flow into the pressure chamber 276d from the pump inlet channel 77 by the amount corresponding to the elimination of the displacement of the volume of the piezoelectric element 273.

### Period T23

After the period T24 has elapsed, the potential of the pump control signal 605b transitions from 0 V to 3.3 V. After the potential of the pump control signal 605b transitions to 3.3 V, the potential of the pump control signal 605b is maintained at 3.3 V during a period T23. In the present embodiment, it is assumed that the period T23=16 ms as in the period T12. During the period T23, the potential of the pump drive signal 608b transitions from 72 V to 0 V, and the potential of the pump drive signal 608b is maintained at 0 V. In the meanwhile, the potential of the pump drive signal 608a is maintained at 72 V. Therefore, the potential difference between the second electrode 274 and the first electrode 272 becomes −72 V. Therefore, due to the displacement in the volume of the piezoelectric element 273, the inks flow out from the pressure chamber 276d to the pump outlet channel 78. In the present embodiment, it is assumed that the period T23=16 ms.

### Period T28

After the period T23 has elapsed, the potential of the pump control signal 605b transitions from 3.3 V to 0 V. After the potential of the pump control signal 605b transitions to 0 V, the potential of the pump control signal 605b is maintained at 0 V, and the potential of the pump control signal 605a is also maintained at 0 V during a period T28. Therefore, no potential difference occurs between the second electrode 274 and the first electrode 272. Accordingly, the displacement in the volume of the piezoelectric element 273 is eliminated. Therefore, the inks flow out from the pressure chamber 276d to the pump outlet channel 78 by the amount corresponding to the displacement in the volume of the piezoelectric element 273.

After the period T28 has elapsed, the potential of the pump control signal 605a transitions from 0 V to 3.3 V again. That is, the control in which the periods T22, T24, T23, and T28 form one driving cycle T27 is repeatedly performed. In the present embodiment, it is assumed that the period T28=16 ms. In other words, one driving cycle T27 includes the periods T25a and T25b during which a potential difference is applied to the piezoelectric element 273, and the periods T26a and T26b during which no potential difference is applied to the piezoelectric element 273.

### Effects of Second Embodiment

According to the present embodiment, when the pressure chamber 276d expands or contracts, the volume of the piezoelectric element 273 goes through a state of no displacement for a predetermined time period. Specifically, the driving cycle T27 includes the periods T25a and T25b during which a potential difference is applied to the piezoelectric element 273, and the periods T26a and T26b during which no potential difference is applied to the piezoelectric element 273. In the example of FIG. 11, during one driving cycle T27, each of the periods T25a, T26a, T25b, and T26b occurs in this order. Each period can be adjusted by adjusting the time intervals of the periods T22, T24, T23, and T28. Therefore, it is possible to relatively finely control the inflow and outflow of the inks into and from the pressure chamber 276d.

In addition, the drive-control unit may control the distortion generated in the piezoelectric unit in the order of a first sub-cutoff period (the period T22), a third period (the period T24), a second sub-cutoff period (the period T23), and a fourth period (the period T28). The first sub-cutoff period (the period T22) is a period during which the driving voltage (the pump drive voltage 607) supplied to the first electrode 272 is cut off. The second sub-cutoff period (the period T23) is a period during which the driving voltage (the pump drive voltage 607) supplied to the second electrode 274 is cut off. With such a configuration, it is possible to include, in one driving cycle T27, a plurality of periods T25a during which a potential difference is applied to the piezoelectric element 273, and a plurality of periods T26a during which no potential difference is applied to the piezoelectric element 273. Accordingly, it becomes possible to finely control the period for maintaining the liquid circulating capability, and the period for suppressing migration failure.

When the driving voltage (the pump drive voltage 607) supplied to the first electrode 272 is cut off, the following setting may be performed for each of the third period (the period T24) and the fourth period (the period T28). That is, a time period longer than the time period required for the driving voltage (the pump drive voltage 607) supplied to the first electrode 272 to reach a predetermined potential after supplying of the driving voltage (the pump drive voltage 607) is resumed may be set. When the driving voltage (the pump drive voltage 607) supplied to the second electrode 274 is cut off, the following setting may be performed for each of the third period (the period T24) and the fourth period (the period T28). That is, a time period longer than the time period required for the driving voltage (the pump drive voltage 607) supplied to the second electrode 274 to reach a predetermined potential after supplying of the driving voltage (the pump drive voltage 607) is resumed may be set. According to such a configuration, it is possible to realize a period for suppressing migration failure a plurality of times in one driving cycle T27.

When the driving voltage (the pump drive voltage 607) supplied to the first electrode 272 is cut off, a time period longer than the time period for the potential of the driving voltage (the pump drive voltage 607) supplied to the first electrode 272 to reach zero potential may be set to the first sub-cutoff period (the period T22). When the driving voltage (the pump drive voltage 607) supplied to the second electrode 274 is cut off, a time period longer than the time period for the potential of the driving voltage supplied to the second electrode to reach zero potential may be set to the second sub-cutoff period (the period T23). According to such a configuration, sufficient liquid circulating capability can be maintained.

### Third Embodiment

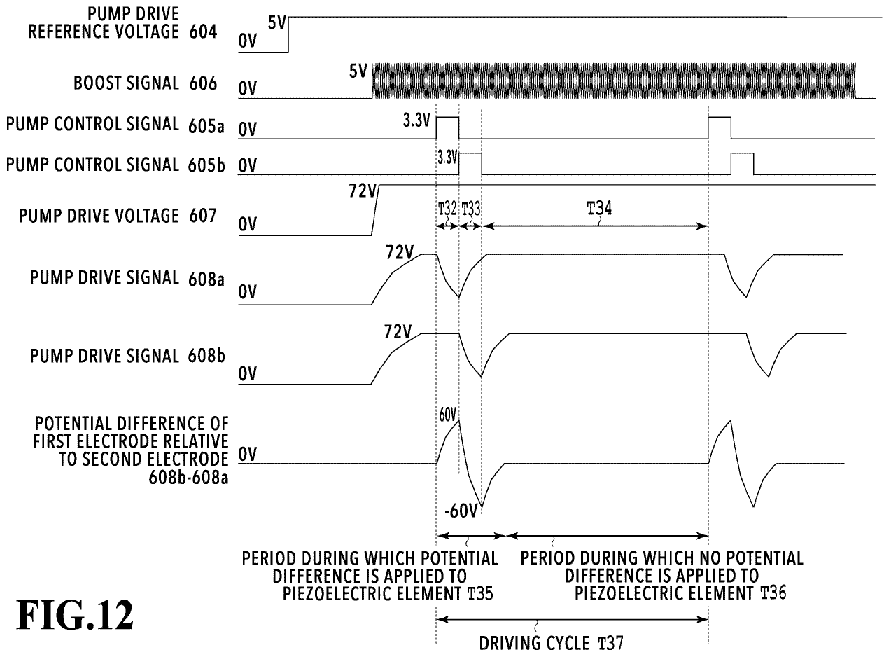

In a third embodiment, a description of configurations that are identical to those in the first and second embodiments will be omitted as appropriate. The third embodiment is different from the first and second embodiments in that the potential difference between the second electrode 274 and the first electrode 272 does not reach 72 V. FIG. 12 is a diagram for describing a timing chart of the control signal that controls the pump driving circuit according to the third embodiment. The timing chart in FIG. 12 is identical to the timing chart for the pump driving circuit in the first and second embodiments, until the potential of the pump drive voltage 607 is boosted to 72 V from 0 V. Hereinafter, the timing chart that is different from that in the first and second embodiments will be described.

### Period T32

After the potential of the pump drive voltage 607 transitions to 72 V, the potential of the pump control signal 605a transitions from 0 V to 3.3 V. After the potential of the pump control signal 605a transitions to 3.3 V, the potential of the pump control signal 605a is maintained at 3.3 V during a period T32. When the potential of the pump control signal 605a transitions to 3.3 V, the potential of the pump drive signal 608a is scheduled to transition from 72 V to 0 V during a transition time period T31, but the period T32 is shorter than the transition time period T31. Therefore, the potential of the pump drive signal 608a does not transition to 0 V. That is, the transition time period T31 is the time period until the potential of the pump drive signal 608a transitions from 72 V to 0 V. However, although details will be described later, in an example of FIG. 12, the period T32 ends at the time when the potential of the pump drive signal 608a reaches 12 V before transitioning to 0 V, and the potential of the pump control signal 605a transitions from 3.3 V to 0 V. Therefore, the potential of the pump drive signal 608a is inverted to 72 V again. Therefore, the transition time period T31 is not illustrated in FIG. 12. For example, it is assumed that the transition time T31=12 ms, and it is assumed that the period T32=10 ms. In the meanwhile, while the potential of the pump control signal 605a is maintained at 3.3 V, the potential of the pump control signal 605b is maintained at 0 V. Therefore, the potential of the pump drive signal 608b is maintained at 72 V. In the period T32, the potential difference between the potential of the pump drive signal 608b and the potential of the pump drive signal 608a becomes 60 V at maximum. That is, the potential difference between the second electrode 274 and the first electrode 272 becomes 60 V at maximum. Therefore, the volume of the piezoelectric element 273 is displaced, and the inks flow into the pressure chamber 276d from the pump inlet channel 77.

### Period T33

Next, the potential of the pump control signal 605a transitions from 3.3 V to 0 V. At the same time the potential of the pump control signal 605a transitions to 0 V, the potential of the pump control signal 605b transitions from 0 V to 3.3 V. After the potential of the pump control signal 605b transitions to 3.3 V, the potential of the pump control signal 605b is maintained at 3.3 V during a period T33. When the potential of the pump control signal 605b transitions to 3.3 V, the potential of the pump drive signal 608b is scheduled to transition from 72 V to 0 V during the transition time period T31, but the period T33 is shorter than the transition time period T31. Therefore, the potential of the pump drive signal 608b does not transition to 0 V. That is, the transition time period T31 is the time period until the potential of the pump drive signal 608b transitions from 72 V to 0 V. However, in the example of FIG. 12, the period T33 ends at the time when the potential of the pump drive signal 608b reaches 12 V before transitioning to 0 V, and the potential of the pump control signal 605b transitions from 3.3 V to 0 V. Therefore, the potential of the pump drive signal 608b is inverted to 72 V again. For example, it is assumed that the transition time period T31=12 ms, and it is assumed that the period T33 =10 ms as in the period T32. In the meanwhile, while the potential of the pump control signal 605b is maintained at 3.3 V, the potential of the pump control signal 605a is maintained at 0 V. Therefore, the potential of the pump drive signal 608a is transitioning toward 72 V. In the period T33, the potential difference between the potential of the pump drive signal 608a and the potential of the pump drive signal 608b becomes −60 V at maximum. That is, the potential difference between the second electrode 274 and the first electrode 272 becomes −60 V at maximum. Therefore, the volume of the piezoelectric element 273 is displaced, and the inks flow out from the pressure chamber 276d to the pump outlet channel 78.

### Period T34

After the period T33 has elapsed, the potential of the pump control signal 605b transitions from 3.3 V to 0 V. After the potential of the pump control signal 605b transitions to 0 V, the potential of the pump control signal 605b is maintained at 0 V, and the potential of the pump control signal 605a is also maintained at 0 V during a period T34. Therefore, no potential difference occurs between the second electrode 274 and the first electrode 272. Accordingly, the displacement in the volume of the piezoelectric element 273 is eliminated.

After the period T34 has elapsed, the potential of the pump control signal 605a transitions from 0 V to 3.3 V again. That is, the control in which the periods T32, T33, and T34 form one driving cycle T37 is repeatedly performed. In the present embodiment, it is assumed that the period T34=44 ms. In addition, in other words, one driving cycle T37 includes the period T35 during which a potential difference is applied to the piezoelectric element 273, and the period T36 during which no potential difference is applied to the piezoelectric element 273.

### Effects of Third Embodiment

According to the present embodiment, the potentials of the pump drive signals 608a and 608b are inverted before reaching 0 V. Therefore, although the liquid circulating capability is decreased compared to that in the first and second embodiments, when the decreased liquid circulating capability is sufficient, it is possible to maintain the liquid circulating capability and it is possible to suppress migration failure in the piezoelectric element 273.

When the driving voltage (the pump drive voltage 607) supplied to the first electrode 272 is cut off, a time period shorter than the time period during which the potential of the driving voltage (the pump drive voltage 607) supplied to the first electrode 272 to reach zero potential may be set to the first cutoff period (the period T32). When the driving voltage (the pump drive voltage 607) supplied to the second electrode 274 is cut off, a time period shorter than the time period during which the potential of the driving voltage (the pump drive voltage 607) supplied to the second electrode 274 to reach zero potential may be set to the second cutoff period (the period T33). According to such a configuration, it is possible to reduce the proportion of the period T35 during which a potential difference is applied to the piezoelectric element 273, and to increase the proportion of the period T36 during which no potential difference is applied to the piezoelectric element 273, in one driving cycle T37.

### Fourth Embodiment

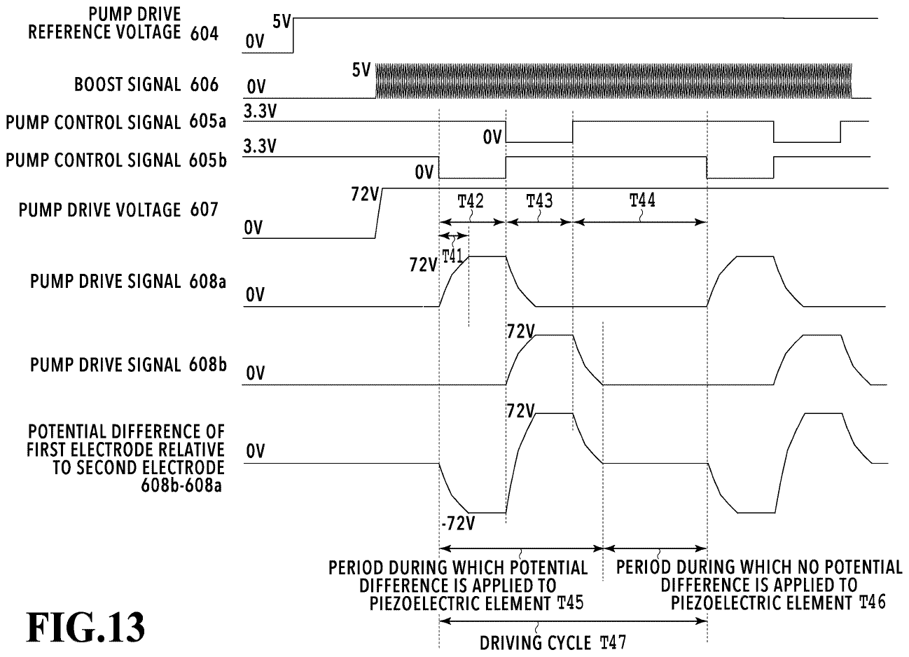

In a fourth embodiment, a description of configurations that are identical to those in the first to third embodiments will be omitted as appropriate. The fourth embodiment is different from the first to third embodiments in which the pump control signals 605a and 605b are set to active high (positive logic) in that the pump control signals 605a and 605b are set to active low (negative logic). That is, in the first to third embodiments, although the description has been given of the example in which the second period includes, as the period during which no potential difference occurs between the two electrodes, the period during which the driving voltage is simultaneously supplied to each of the two electrodes, this is not a limitation. In the fourth embodiment, a description will be given of an example in which the second period includes, as the period during which no potential difference occurs between the two electrodes, a period during which the driving voltage supplied to each of the two electrodes is simultaneously cut off with reference to FIG. 13. FIG. 13 is a diagram for describing a timing chart of a control signal that controls a pump driving circuit according to the fourth embodiment. In the example of FIG. 13, the signal potentials of the pump control signals 605a and 605b are inverted. Therefore, when both potentials of the pump control signals 605a and 605b are 3.3 V, the potentials of the pump drive signals 608a and 608b are maintained at 0 V. In the meanwhile, when both potentials of the pump control signals 605a and 605b are 0 V, the potentials of the pump drive signals 608a and 608b transition from 0 V to 72 V. Accordingly, in the present embodiment, when both potentials of the pump control signals 605a and 605b are 3.3 V, no potential difference is applied to the piezoelectric element 273. Therefore, it is possible to obtain the same effects as those in the first embodiment. For example, in FIG. 13, the potential of the pump control signal 605a transitions from 0 V to 3.3 V from a period T43 to a period T44. Therefore, the potential of the pump drive signal 608a transitions from 72 V to 0 V. In the meanwhile, the potential of the pump control signal 605b is maintained at 3.3 V from the period T43 to the period T44. Therefore, the potential of the pump drive signal 608b is maintained at 0 V. Accordingly, in the second period (the period T44), since both potentials of the pump control signals 605a and 605b are 3.3 V, the potential of each of the pump drive signals 608a and 608b is 0 V. In other words, due to the pump drive signals 608a and 608b, the second period (the period T44) includes a period during which the pump drive voltage 607 supplied to each of the first electrode 272 and the second electrode 274 is simultaneously cut off.

### Effects of Fourth Embodiment

The second period (the period T44) may include, as the period during which no potential difference occurs between the first electrode 272 and the second electrode 274, a period during which the driving voltage (the pump drive voltage 607) supplied to each of the first electrode 272 and the second electrode 274 is simultaneously cut off. That is, the second period (the period T44) includes the period during which the driving voltage (the pump drive voltage 607) is not simultaneously supplied to each of the first electrode 272 and the second electrode 274. According to such a configuration, since no potential difference occurs between the two electrodes in the second period (the period T44), it does not mean that a voltage is applied between the two electrodes. Therefore, in the second period (the period T44), even when the piezoelectric pump is in a highly humid environment, the piezoelectric pump will not be under the condition that a voltage is applied. Therefore, migration failure can be suppressed.

### Fifth Embodiment

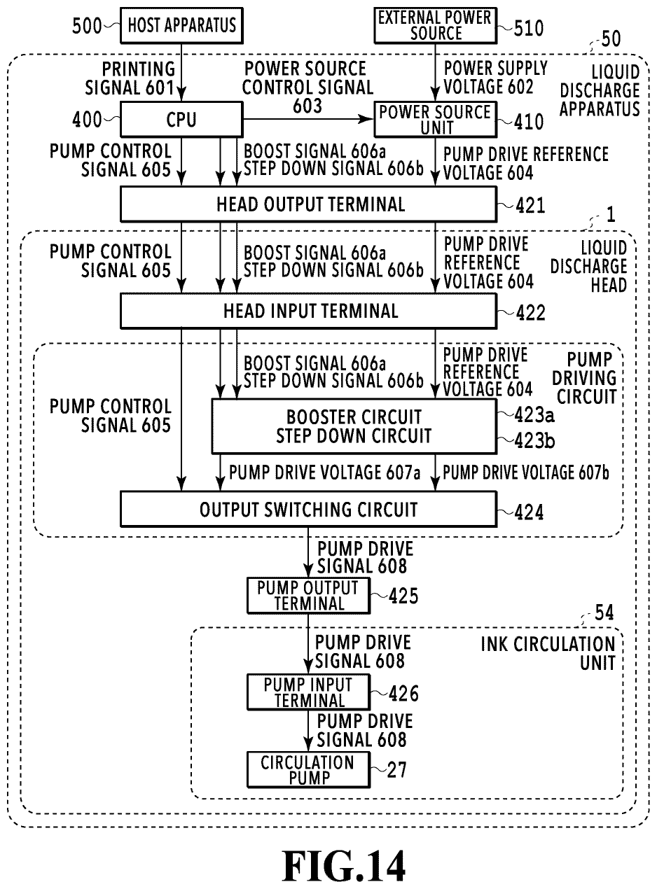

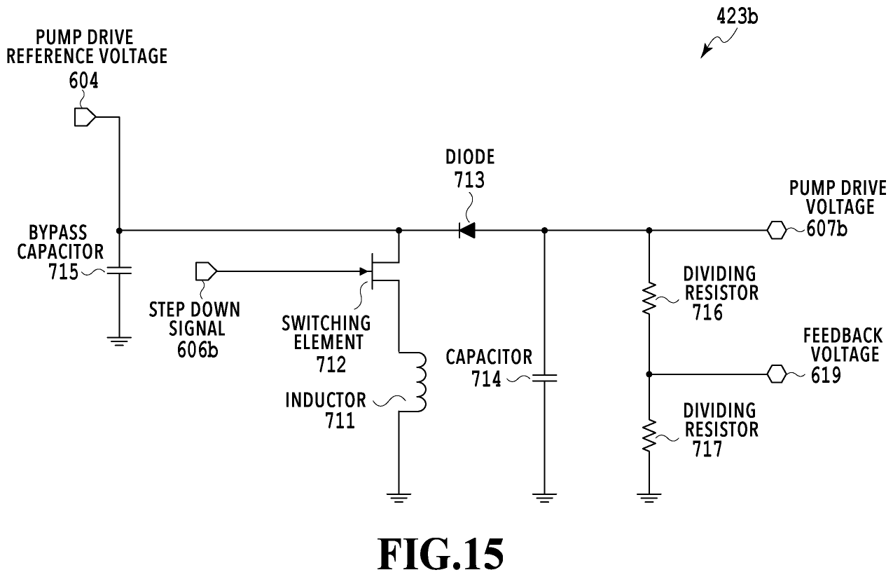

In a fifth embodiment, a description of configurations that are identical to those in the first to fourth embodiments will be omitted as appropriate. The fifth embodiment is different from the first to fourth embodiments in that the pump driving circuit further includes a step down circuit 423b, and in that the configuration of the output switching circuit 424 is modified by further including the step down circuit 423b. FIG. 14 is a diagram illustrating an example of a pump driving circuit that drives the circulation pump in FIG. 6 according to the fifth embodiment. As illustrated in FIG. 14, a step down signal 606b and the pump drive reference voltage 604 are input to the step down circuit 423b. The step down signal 606b is generated by the CPU 400. The step down signal 606b generated by the CPU 400 is sent to the step down circuit 423b via the head output terminal 421 and the head input terminal 422. A pump drive voltage 607a and a pump drive voltage 607b are sent to the output switching circuit 424. The pump drive voltage 607a is sent from a booster circuit 423a. The pump drive voltage 607b is sent from the step down circuit 423b. Next, the details of the step down circuit 423b will be described with reference to FIG. 15.

### Step Down Circuit 423b

FIG. FIG. 15 is a diagram illustrating an example of the step down circuit 423b in FIG. FIG. 14 according to the fifth embodiment. The step down circuit 423b includes a bypass capacitor 715, an inductor 711, a switching element 712, a diode 713, a capacitor 714, a dividing resistor 716, and a dividing resistor 717. The inductor 711 of the step down circuit 423b is connected to a position different from that of the inductor 701 of the booster circuit 423a in FIG. FIG. 8. The inductor 711 of the step down circuit 423b is connected between the switching element 712 and the ground terminal. The diode 713 in the step down circuit 423b has its anode and cathode connected in an orientation different from those of the diode 703 in the booster circuit 423a in FIG. 8. Unlike the n-channel FET of the switching element 702 in the booster circuit 423a in FIG. 8, a p-channel FET is used for the switching element 712 in the step down circuit 423b.

### Connection Configuration of Step Down Circuit 423b

One terminal of the bypass capacitor 715 is connected to the ground terminal. The other terminal of the bypass capacitor 715 is connected to a voltage input terminal of the step down circuit 423b. The pump drive reference voltage 604 is applied to the voltage input terminal of the step down circuit 423b. In addition, the input terminal of the step down circuit 423b is connected to the cathode of the diode 713 and is connected to the drain of the switching element 712. The inductor 711 is connected between the source of the switching element 712 and the ground terminal. When the step down signal 606b input from the signal input terminal of the step down circuit 423b is input to the gate of the switching element 712, the drain of the switching element 712 and source of the switching element 712 are in a conductive state. It should be noted that the step down signal 606b is a negative voltage. One terminal of the capacitor 714 is connected to the anode of the diode 713. The other terminal of the capacitor 714 is connected to the ground terminal. In addition, one terminal of the dividing resistor 716 and a first voltage output terminal of the step down circuit 423b are connected to the anode of the diode 713. The first voltage output terminal can output the pump drive voltage 607b. One terminal of the dividing resistor 717 is connected to the other terminal of the dividing resistor 716. The ground terminal is connected to the other terminal of the dividing resistor 717. A second voltage output terminal of the step down circuit 423b is connected to the connection point between the dividing resistor 716 and the dividing resistor 717. The second voltage output terminal can output a feedback voltage 619.

### Operation of Step Down Circuit 423b

When the pump drive reference voltage 604 is applied to the voltage input terminal of the step down circuit 423b and the switching element 712 is in a non-conductive state, charge is accumulated in the capacitor 714. In the meanwhile, when the pump drive reference voltage 604 is applied to the voltage input terminal of the step down circuit 423b and the switching element 712 is in a conductive state, the charge accumulated in the capacitor 714 flows out into the inductor 711, and negative charge is accumulated in the inductor 711. Therefore, by repeating the non-conductive state and the conductive state of the switching element 712, negative charge continues to be accumulated in the inductor 711, and the potential of the pump drive voltage 607b output from the step down circuit 423b becomes a negative potential. Next, the output switching circuit 424 will be described with reference to FIG. FIG. 16.

### Output Switching Circuit 424

FIG. FIG. 16 is a diagram illustrating an example of the output switching circuit 424 in FIG. FIG. 14 according to the fifth embodiment. In FIG. FIG. 16, the output switching circuit 424 is composed of a circuit constituted by a group of elements denoted by symbols appended by “a” as a suffix and a circuit constituted by a group of elements denoted by symbols appended by “b” as a suffix.

### Connection Configuration of Output Switching Circuit 424

### In Case that Suffix is A

The output switching circuit 424 includes an NPN transistor 812a, an NPN transistor 813a, a PNP transistor 814a, and a PNP transistor 815a. The pump drive voltage 607a is applied to the collector of the NPN transistor 812a. The collector of the NPN transistor 813a is connected to the base of the NPN transistor 812a. The emitter of the PNP transistor 814a is connected to the emitter of the NPN transistor 812a. The pump drive signal 608a is output from the connection point between the emitter of the NPN transistor 812a and the emitter of the PNP transistor 814a. The ground terminal is connected to the emitter of the NPN transistor 813a. An input terminal of the pump control signal 605a and the base of the PNP transistor 815a are connected to the base of the NPN transistor 813a. The base of the PNP transistor 814a is connected to the collector of the PNP transistor 815a. The pump drive voltage 607b is applied to the collector of the PNP transistor 814a.

### connection Configuration of Output Switching Circuit 424

### In Case that Suffix is B

The output switching circuit 424 includes an NPN transistor 812b, an NPN transistor 813b, a PNP transistor 814b, and a PNP transistor 815b. The pump drive voltage 607a is applied to the collector of the NPN transistor 812b. The collector of the NPN transistor 813b is connected to the base of the NPN transistor 812b. The emitter of the PNP transistor 814b is connected to the emitter of the NPN transistor 812b. The pump drive signal 608b is output from the connection point between the emitter of the NPN transistor 812b and the emitter of the PNP transistor 814b. The ground terminal is connected to the emitter of the NPN transistor 813b. An input terminal of the pump control signal 605b and the base of the PNP transistor 815b are connected to the base of the NPN transistor 813b. The base of the PNP transistor 814b is connected to the collector of the PNP transistor 815b. The pump drive voltage 607b is applied to the collector of the PNP transistor 814b.

### Operation of Output Switching Circuit 424

When the potential of the pump control signal 605 is 3.3 V, the NPN transistors 812, 813 are in a conductive state, and the PNP transistors 814, 815 are in a non-conductive state. In this case, the pump drive voltage 607a is output to the pump drive signal 608. In the meanwhile, when the potential of the pump control signal 605 is 0 V, the NPN transistors 812 and 813 are in a non-conductive state, and the PNP transistors 814 and 815 are in a conductive state. In this case, the pump drive voltage 607b is output to the pump drive signal 608. Next, the driving of the circulation pump 27 will be described with reference to FIG. FIG. 17.

### Driving of Circulation Pump 27

FIG. FIG. 17 is a diagram for describing a timing chart of a control signal that controls the pump driving circuit according to the fifth embodiment. First, the potential of the pump drive reference voltage 604 transitions from 0 V to 5 V. Accordingly, the pump drive reference voltage 604 is applied to each of the booster circuit 423a and the step down circuit 423b. Next, the potential of each of the boost signal 606a and the step down signal 606b repeatedly transitions from 0 V to 5 V according to a predetermined rule. Accordingly, the potential of the pump drive voltage 607a is boosted to 36 V from 0 V, and the potential of the pump drive voltage 607b is stepped down from 0 V to −36 V.

### Period T52

Next, the potential of the pump control signal 605a transitions from 0 V to 3.3 V. When the potential of the pump control signal 605a is 3.3 V, the potential of the pump control signal 605b is 0 V. After the potential of the pump control signal 605a transitions to 3.3 V, the potential of the pump control signal 605a is maintained at 3.3 V during a period T52. In the meanwhile, since the potential of the pump control signal 605a transitions to 3.3 V, the potential of the pump drive signal 608a is decreased from 36 V to −36 V during a transition time period T51. In addition, in the present embodiment, it is assumed that the period T52=16 ms. While the potential of the pump drive signal 608a is being decreased, since the potential of the pump control signal 605b is maintained at 0 V, the potential of the pump drive signal 608b is maintained at 36 V. After reaching −36 V, the potential of the pump drive signal 608a remains at −36 V during the period T52 during which the pump control signal 605a is maintained at 3.3 V. Therefore, in the period T52, there is a period during which the potential difference between the potential of the pump drive signal 608a and the potential of the pump drive signal 608b becomes 72 V. In this period, the potential difference between the second electrode 274 and the first electrode 272 is 72 V. Due to this potential difference, the volume of the piezoelectric element 273 is displaced, and the inks flow into the pressure chamber 276d from the pump inlet channel 77.

### Period T53

Next, the potential of the pump control signal 605a transitions to 0 V, and simultaneously, the potential of the pump control signal 605b transitions from 0 V to 3.3 V. After the potential of the pump control signal 605b transitions to 3.3 V, the potential of the pump control signal 605b is maintained at 3.3 V during a period T53. In the meanwhile, since the potential of the pump control signal 605b transitions to 3.3 V, the potential of the pump drive signal 608b is decreased from 36 V to −36 V. After reaching −36 V, the potential of the pump drive signal 608b remains at −36 V during the period T53 during which the pump control signal 605b is maintained at 3.3 V. In addition, in the present embodiment, it is assumed that the period T53=16 ms as in the period T52. While the potential of the pump drive signal 608b is being decreased, since the potential of the pump control signal 605a is maintained at 0 V, the potential of the pump drive signal 608a transitions from −36 V to 36 V. After the potential of the pump drive signal 608a reaches 36 V, the pump drive signal 608a is maintained at 36 V while the potential of the pump control signal 605a is maintained at 0 V. Therefore, in the period T53, there is a period during which the potential difference between the potential of the pump drive signal 608a and the potential of the pump drive signal 608b becomes −72 V. In this period, the potential difference between the second electrode 274 and the first electrode 272 is −72 V. Due to this potential difference, the volume of the piezoelectric element 273 is displaced, and the inks flow out from the pressure chamber 276d to the pump outlet channel 78.

### Period T54; Period T55; period T56; Driving Cycle T57

After the period T53 has elapsed, the potential of the pump control signal 605b transitions from 3.3 V to 0 V. The potential of the pump control signal 605b transitions to 0 V, and simultaneously, the potential of the pump drive signal 608b transitions from −36 V to 36 V. After the potential of the pump drive signal 608b reaches 36 V, since the potential of the pump control signal 605b remains at 0 V, the potential of the pump drive signal 608b is maintained at 36 V. In the meanwhile, the potential of the pump control signal 605a remains at 0 V. Therefore, the potential of the pump drive signal 608a continues to be maintained at 36 V. As a result, no potential difference occurs between the first electrode 272 and the second electrode 274. Accordingly, the displacement in the volume of the piezoelectric element 273 is eliminated. The inks flow into the pressure chamber 276d from the pump inlet channel 77 by the amount corresponding to the elimination of the displacement of the shape of the piezoelectric element 273. At the same time the period T53 ends, a period T54 is started, and while the period T54 continues, the potential of each of the pump control signal 605a and the pump control signal 605b is maintained at 0 V. In the present embodiment, the period T54=32 ms. After the period T54 has elapsed, the potential of the pump control signal 605a transitions to 3.3 V again during the period T52. That is, the control in which the periods T52, T53, and T54 form one driving cycle T57 is repeatedly performed. In other words, one driving cycle T57 includes a period T55 during which a potential difference is applied to the piezoelectric element 273, and a period T56 during which no potential difference is applied to the piezoelectric element 273.

### Effects of Fifth Embodiment

According to the present embodiment, it is possible to make the potential difference between the first electrode 272 and the second electrode 274 twice the absolute value of the voltage of the pump drive voltage 607. That is, it is possible to make the amount of displacement of the volume of the piezoelectric element 273 relatively large with a relatively low pump drive voltage.

Specifically, the liquid discharge apparatus 50 may include a booster unit and a step down unit. The booster unit supplies a boost voltage obtained by boosting a driving voltage based on a drive reference voltage. The step down unit supplies a step down voltage obtained by stepping down the driving voltage based on the drive reference voltage. The magnitude of the potential of the boost voltage and the magnitude of the potential of the step down voltage may be controlled to be the same, and the direction of the boost voltage and the direction of the step down voltage may be controlled to be opposite to each other. With such an operation, it is possible to make the potential difference between the first electrode 272 and the second electrode 274 twice the absolute value of the voltage of the pump drive voltage 607.

### Sixth Embodiment

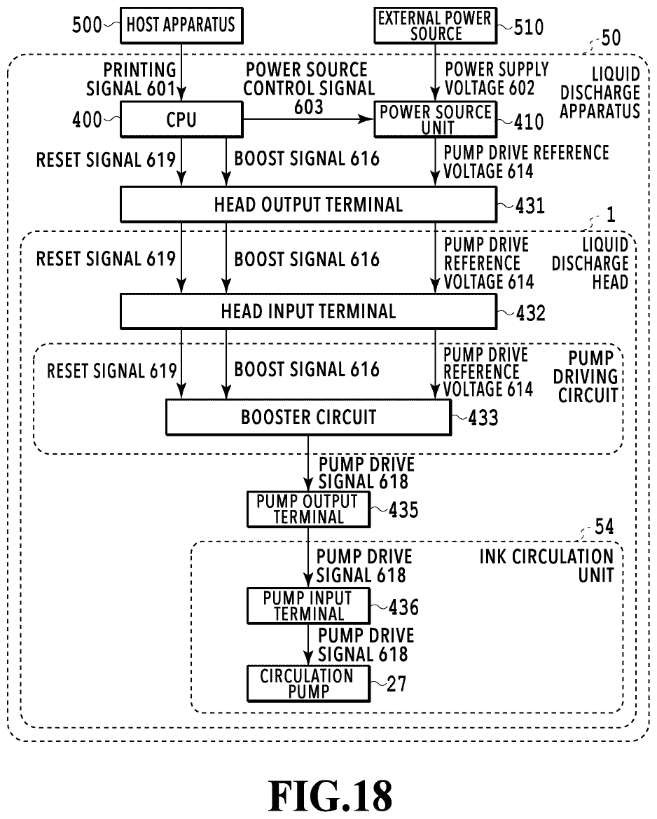

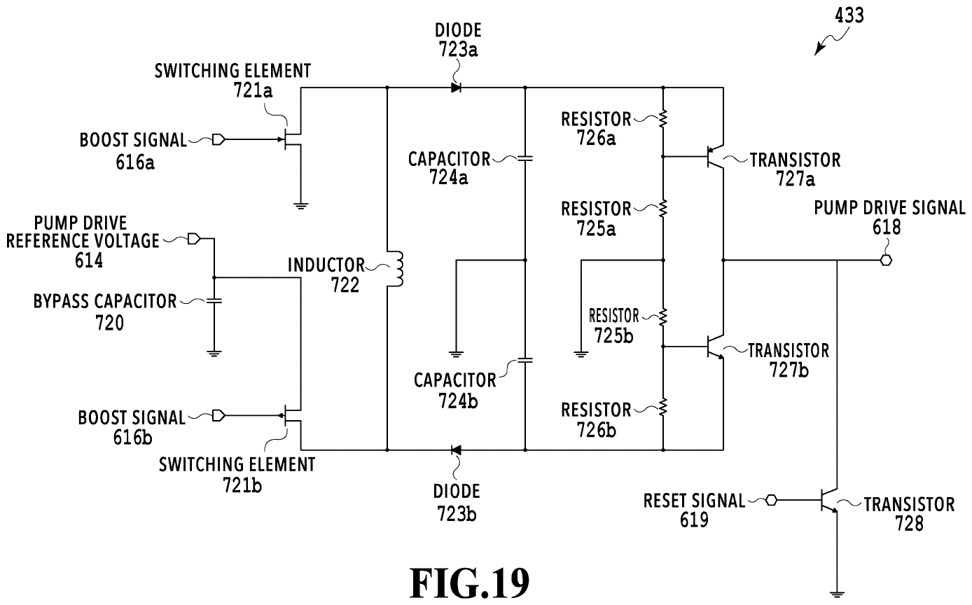

In a sixth embodiment, a description of configurations that are identical to those in the first to fifth embodiments will be omitted as appropriate. The sixth embodiment is different from the first to fifth embodiments in that the pump driving circuit sends the pump drive signal 618 output from the booster circuit 433 to the pump output terminal 435 without passing through the output switching circuit 424. FIG. 18 is a diagram illustrating an example of a pump driving circuit that drives the circulation pump 27 in FIG. 6 according to the sixth embodiment. The booster circuit 433 in FIG. 18 generates the pulsed pump drive signal 618. In addition, the pump drive signal 618 is output to the first electrode 272 via the first wiring 211a. In the present embodiment, the second electrode 274 is connected to the ground terminal via the second wiring 211b. Next, the configuration of the booster circuit 433 will be described with reference to FIG. FIG. 19.

### Overview of Configuration of Booster Circuit 433

FIG. FIG. 19 is a diagram illustrating an example of the booster circuit 433 in FIG. FIG. 18 according to the sixth embodiment. The booster circuit 433 has a configuration in which a step down circuit is added, compared with the booster circuit 423 in the first embodiment. In this step down circuit, while an inductor 722 of a circuit element that realizes a booster circuit is used as a common element, a switching element 721b, a diode 723b, and a capacitor 724b function as a step down circuit. That is, the booster circuit 433 has the function of the booster circuit 423 in FIG. FIG. 8, and the function of the step down circuit 423b in FIG. FIG. 15. In addition, an NPN transistor 728 is incorporated in the booster circuit 433 as a circuit for resetting the output of the pump drive signal 618. Next, the overview of the operation of the booster circuit 433 will be described.

### Overview of Operation of Booster Circuit 433

When the potential of a boost signal 616b is maintained at 0 V, and the potential of a boost signal 616a alternately transition to 5 V and 0 V, charge is accumulated in a capacitor 724a, and the potential of the pump drive signal 618 is boosted to 72 V. In addition, when the potential of the boost signal 616a is maintained at 5 V, and the potential of the boost signal 616b alternately transitions 5 V and 0 V, charge flows out of the capacitor 724b, and the potential of the pump drive signal 618 is stepped down to-72 V. When the potential of a reset signal 629 is 5 V, the NPN transistor 728 is in a conductive state, and the potential of the pump drive signal 618 becomes 0 V.

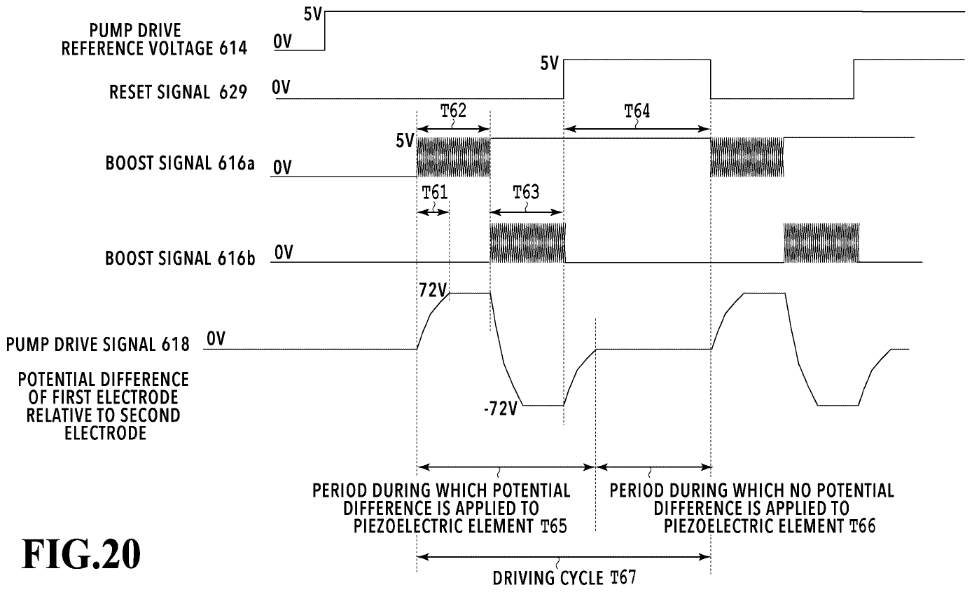

FIG. FIG. 20 is a diagram for describing a timing chart of a control signal that controls the pump driving circuit according to the sixth embodiment. First, the potential of the pump drive reference voltage 614 transitions from 0 V to 5 V. Accordingly, the pump drive reference voltage 614 is applied to the booster circuit 433. Next, the potential of the boost signal 616b is maintained at 0 V, and the potential of the boost signal 616a repeatedly transitions from 0 V to 5 V in a period T62 according to a predetermined rule. For example, the potential of the boost signal 616a alternates between 0 V and 5 V based on a predetermined duty ratio. Accordingly, the potential of the pump drive signal 618 output from the booster circuit 433 is boosted from 0 V to 72 V. In the period T62, the potential of the pump drive signal 618, that is, the potential difference between the first electrode 272 and the second electrode 274 connected to the ground terminal, becomes 72 V. Due to this potential difference, the volume of the piezoelectric element 273 is displaced, and the inks flow into the pressure chamber 276d from the pump inlet channel 77. In the present embodiment, it is assumed that the transition time period T 61=12 ms. In addition, in the present embodiment, it is assumed that the period T62=16 ms.

Next, the potential of the boost signal 616a is maintained at 5 V, and the potential of the boost signal 616b repeatedly transitions from 0 V to 5 V in a period T63 according to a predetermined rule. For example, the potential of the boost signal 616b alternates between 0 V and 5 V based on a predetermined duty ratio. Accordingly, the potential of the pump drive signal 618 output from the booster circuit 433 is stepped downed from 72 V to −72 V. In the period T63, the potential of the pump drive signal 618, that is, the potential difference between the first electrode 272 and the second electrode 274 connected to the ground terminal, becomes −72 V. Due to this potential difference, the volume of the piezoelectric element 273 is displaced, and the inks flow out from the pressure chamber 276d to the pump outlet channel 78. In the present embodiment it is assumed that the period T63=16 ms.

Then, in a period T64, the boost signal 616a is maintained at 5 V, the boost signal 616b is maintained at 0 V, and the potential of the reset signal 629 transitions from 0 V to 5 V. Due to the reset signal, the pump drive signal 618 transitions from −72 V to 0 V. In the period T64, no potential difference occurs between the first electrode 272 and the second electrode 274. Therefore, the displacement of the piezoelectric element 273 is eliminated. Accordingly, the inks flow into the pressure chamber 276d from the pump inlet channel 77 by the amount corresponding to the elimination of the displacement in the volume of the piezoelectric element 273. In the present embodiment, the period T64=32 ms. After the period T64 has elapsed, the potential of the reset signal 629 transitions to 0 V, and the potential of the boost signal 616a repeatedly transitions from 0 V to 5 V in the period T62 according to a predetermined rule. That is, the control in which the periods T62, T63, and T64 form one driving cycle T67 is repeatedly performed.

### Effects of Sixth Embodiment

As in the present embodiment, by alternately transitioning the potential of one electrode of the circulation pump 27 between a positive voltage and a negative voltage, it is possible to connect the other electrode to the ground terminal, and to also drive the circulation pump 27.

In addition, in the first period, while a positive voltage and a negative voltage is supplied to either one of the first electrode 272 and the second electrode 274 for a predetermined time period, the voltage of the other one of the first electrode 272 and the second electrode 274 may be maintained at zero potential. In the second period, the potentials of the voltages supplied to the first electrode 272 and the second electrode 274, respectively, may be controlled to be the same potential. In such an operation, the voltage supplied to either one of the first electrode 272 and the second electrode 274 is controlled. Accordingly, it is possible to realize the driving cycle T67 including a period T65 during which a potential difference is applied to the piezoelectric element 273, and a period T66 during which no potential difference is applied to the piezoelectric element 273.

### Seventh Embodiment

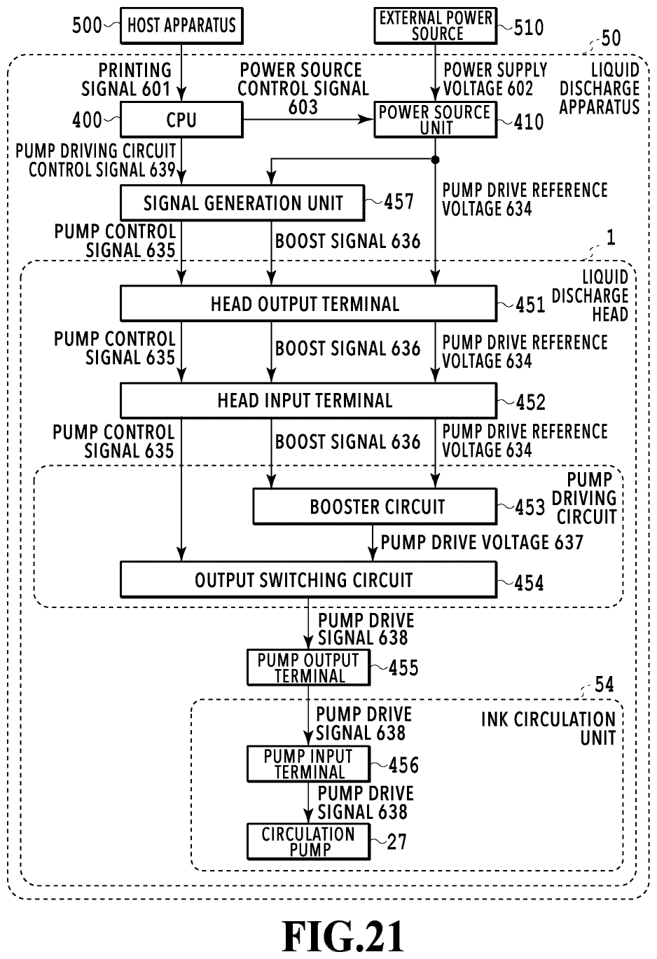

In a seventh embodiment, a description of configurations that are identical to those in the first to sixth embodiments will be omitted as appropriate. The seventh embodiment is different from the first to sixth embodiments in that the body of the liquid discharge apparatus 50 includes a signal generation unit 457. FIG. FIG. 21 is a diagram illustrating an example of a pump driving circuit that drives the circulation pump 27 in FIG. FIG. 6 according to the seventh embodiment. The signal generation unit 457 in FIG. FIG. 21 is constituted by an FPGA (Field Programmable Gate Array). As illustrated in FIG. FIG. 21, by providing the signal generation unit 457 in FIG. FIG. 21 separately from the CPU 400 that controls the body of the liquid discharge apparatus 50, the work load of processing can be dispersed, and therefore it becomes possible to relatively simply perform finer pump control.

In other words, the signal generation unit 457 that generates a pump control signal 635 and a boost signal 636 may be newly provided in addition to the CPU 400. According to such a configuration, by providing the signal generation unit 457 separately from the CPU 400 that controls the body of the liquid discharge apparatus 50, the work load of processing can be dispersed, and therefore it becomes possible to relatively simply perform finer pump control.

### Eighth Embodiment

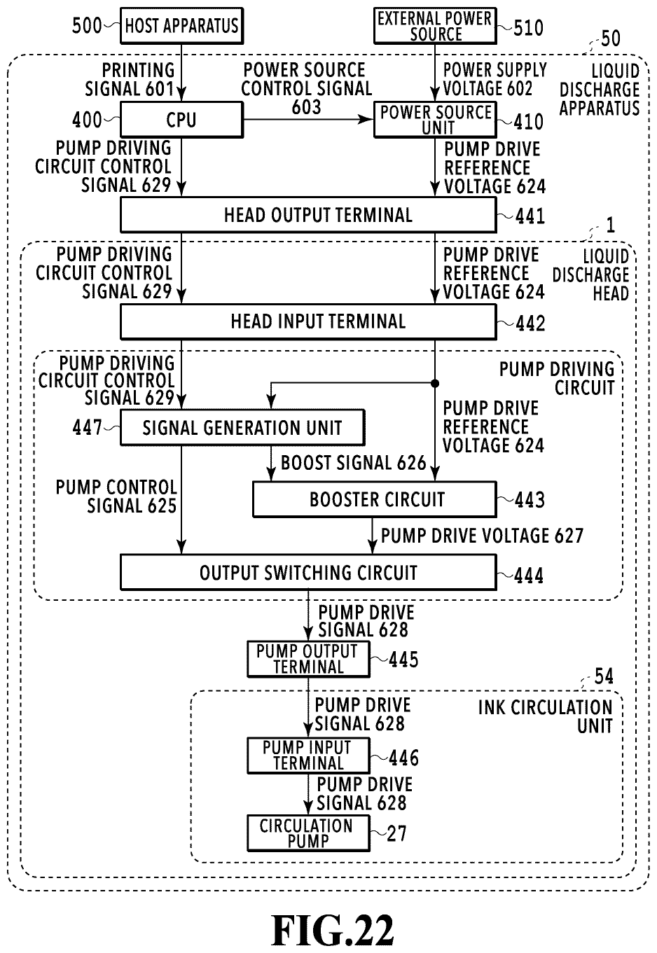

In an eighth embodiment, a description of configurations that are identical to those in the first to seventh embodiments will be omitted as appropriate. The eighth embodiment is different from the first embodiment through seventh embodiment in that the pump driving circuit includes a signal generation unit 447. FIG. FIG. 22 is a diagram illustrating an example of a pump driving circuit that drives the circulation pump 27 in FIG. FIG. 6 according to the eighth embodiment. As illustrated in FIG. FIG. 22, in a system in which the circulation pump 27 is provided to the liquid discharge head 1, the wiring distance of wiring that connects the signal generation unit 447, the booster circuit 443, and the output switching circuit 444 in FIG. FIG. 22 can be shortened, and the number of electrical contacts can be reduced. That is, the quality of the pump drive signal can be improved.

In other words, the signal generation unit 447 that generates a boost signal 626 and generates a pump control signal 625 may be provided on the same substrate in which the booster circuit 443 and the output switching circuit 444 are mounted. According to such a configuration, it is possible to shorten the length of wiring that electrically connects each of the signal generation unit 447, the booster circuit 443, and the output switching circuit 444. Therefore, since the wiring impedance can be reduced, the quality of the pump drive signal can be improved.

Although various examples and embodiments of the present disclosure have been illustrated and described above, the spirit and scope of the present disclosure are not limited to specific descriptions herein. The present disclosure is not limited to the above-described embodiments, and various modifications may be made. In addition, the present disclosure allows appropriate combinations of a part of the above-described embodiments.

### Modification 1

For example, although the descriptions have been given of the examples in which the liquid discharge head 1 includes the booster circuit 423, or the booster circuit 423a and the step down circuit 423b, or the booster circuit 433, or the booster circuit 443, or the booster circuit 453, this is not a particular limitation. For example, the liquid discharge head 1 may include a DC-DC converter. When the DC-DC converter includes a boosting function, the DC-DC converter can realize the function of the booster circuit 423 and the like. In addition, when the DC-DC converter includes a step down function, the DC-DC converter can realize the function of the step down circuit 423b.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to achieve maintaining of the liquid circulating capability and suppression of migration failure.

This application claims the benefit of Japanese Patent Application No. 2024-202256, filed Nov. 20, 2024 which is hereby incorporated by reference herein in its entirety.

What is claimed is:

1. A liquid circulation apparatus comprising:
a piezoelectric unit including a first electrode, a second electrode facing the first electrode, and a piezoelectric element arranged between the first electrode and the second electrode;
a drive-control unit for controlling, in a state of a driving voltage generating distortion in the piezoelectric unit supplied to the first electrode and the second electrode, the distortion generated in the piezoelectric unit in a driving cycle including a first period and a second period; and
a diaphragm unit including a vibrating plate for vibrating in response to the distortion generated in the piezoelectric unit, and a pressure chamber for being transmitted vibrations of the vibrating plate, the diaphragm unit circulating liquid flowing in and out of the pressure chamber by the vibrations of the vibrating plate, wherein the first period includes a period during which the driving voltage supplied to either one of the first electrode and the second electrode is cut off, and
the second period includes a period during which no potential difference occurs between the first electrode and the second electrode.

2. The liquid circulation apparatus according to claim 1, wherein the second period includes a period during which the driving voltage is simultaneously supplied to each of the first electrode and the second electrode, as a period during which no potential difference occurs between the first electrode and the second electrode.

3. The liquid circulation apparatus according to claim 2, wherein the drive-control unit includes:
a first voltage control circuit that controls whether or not to cut off the driving voltage supplied to the first electrode; and
a second voltage control circuit that is provided electrically in parallel with the first voltage control circuit, and controls whether or not to cut off the driving voltage supplied to the second electrode.

4. The liquid circulation apparatus according to claim 3, wherein the drive-control unit cuts off the driving voltage supplied to the second electrode by the second voltage control circuit, while the driving voltage is supplied to the first electrode, and cuts off the driving voltage supplied to the first electrode by the first voltage control circuit, while the driving voltage is supplied to the second electrode.

5. The liquid circulation apparatus according to claim 3, further comprising a booster unit for supplying the driving voltage boosted based on a drive reference voltage at the same potential to each of the first voltage control circuit and the second voltage control circuit.

6. The liquid circulation apparatus according to claim 5, wherein the first period includes a first cutoff period during which the driving voltage supplied to the first electrode is cut off, and a second cutoff period during which the driving voltage supplied to the second electrode is cut off, and
the drive-control unit controls the distortion generated in the piezoelectric unit in an order of the first cutoff period, the second cutoff period, and the second period as the driving cycle.

7. The liquid circulation apparatus according to claim 6, wherein the drive-control unit starts the second cutoff period simultaneously with an end of the first cutoff period.

8. The liquid circulation apparatus according to claim 5, wherein the drive-control unit controls the distortion generated in the piezoelectric unit in an order of a first sub-cutoff period during which the driving voltage supplied to the first electrode in the first period is cut off, a third period corresponding to the second period, a second sub-cutoff period during which the driving voltage supplied to the second electrode in the first period is cut off, and a fourth period corresponding to the second period.

9. The liquid circulation apparatus according to claim 8, wherein in a case where the driving voltage supplied to the first electrode is cut off, a time period longer than a time period required for the driving voltage supplied to the first electrode to reach a predetermined potential after supplying of the driving voltage is resumed is set to each of the third period and the fourth period, and in a case where the driving voltage supplied to the second electrode is cut off, a time period longer than a time period required for the driving voltage supplied to the second electrode to reach a predetermined potential after supplying of the driving voltage is resumed is set to each of the third period and the fourth period.

10. The liquid circulation apparatus according to claim 6, wherein in a case where the driving voltage supplied to the first electrode is cut off, a time period longer than a time period for a potential of the driving voltage supplied to the first electrode to reach zero potential is set to the first cutoff period, and
in a case where the driving voltage supplied to the second electrode is cut off, a time period longer than a time period for the potential of the driving voltage supplied to the second electrode to reach zero potential is set to the second cutoff period.

11. The liquid circulation apparatus according to claim 8, wherein in a case where the driving voltage supplied to the first electrode is cut off, a time period longer than a time period for a potential of the driving voltage supplied to the first electrode to reach zero potential is set to the first sub-cutoff period, and
in a case where the driving voltage supplied to the second electrode is cut off, a time period longer than a time period for the potential of the driving voltage supplied to the second electrode to reach zero potential is set to the second sub-cutoff period.

12. The liquid circulation apparatus according to claim 6, wherein in a case where the driving voltage supplied to the first electrode is cut off, a time period shorter than a time period for a potential of the driving voltage supplied to the first electrode to reach zero potential is set to the first cutoff period, and
in a case where the driving voltage supplied to the second electrode is cut off, a time period shorter than a time period for the potential of the driving voltage supplied to the second electrode to reach zero potential is set to the second cutoff period.

13. The liquid circulation apparatus according to claim 2, further comprising:
a booster unit for supplying, to the drive-control unit, a boost voltage obtained by boosting the driving voltage based on a drive reference voltage; and
a step down unit for supplying, to the drive-control unit, a step down voltage obtained by stepping down the driving voltage based on the drive reference voltage, wherein
a magnitude of a potential of the boost voltage and a magnitude of a potential of the step down voltage are controlled to be the same, and a direction of the boost voltage and a direction of the step down voltage are controlled to be opposite to each other.

14. The liquid circulation apparatus according to claim 5, further comprising a signal generation unit for generating a control signal for controlling the drive-control unit, and a boost signal that controls the booster unit.

15. The liquid circulation apparatus according to claim 14, further comprising:
a circuit board including the drive-control unit and the booster unit, thce ircuit board including the signal generation unit.

16. The liquid circulation apparatus according to claim 1, wherein the second period includes a period during which the driving voltage supplied to each of the first electrode and the second electrode is simultaneously cut off, as a period during which no potential difference occurs between the first electrode and the second electrode.

17. A liquid circulation apparatus comprising:
a piezoelectric unit including a first electrode, a second electrode facing the first electrode, and a piezoelectric element arranged between the first electrode and the second electrode;
a drive-control unit for controlling distortion generated in the piezoelectric unit in a driving cycle including a first period and a second period; and
a diaphragm unit including a vibrating plate for vibrating in response to the distortion generated in the piezoelectric unit, and a pressure chamber for being transmitted vibrations of the vibrating plate, the diaphragm unit for circulating liquid flowing in and out of the pressure chamber by the vibrations of the vibrating plate, wherein
in the first period, while a positive voltage and a negative voltage is supplied to either one of the first electrode and the second electrode for a predetermined time period, a voltage of another one of the first electrode and the second electrode is maintained at zero potential, and
in the second period, no potential difference occurs between the first electrode and the second electrode.

18. The liquid circulation apparatus according to claim 17, wherein in the second period, as a period during which no potential difference occurs between the first electrode and the second electrode, a potential of a voltage supplied to each of the first electrode and the second electrode is controlled to be the same potential.

19. A liquid discharge apparatus comprising:
a discharge element substrate including a plurality of discharge elements for discharging liquid;
a channel member hydraulically connected with the discharge element substrate, and including a supply channel for supplying the liquid to the discharge element substrate and a collecting channel for collecting the liquid from the discharge element substrate; and
a liquid circulation unit, the liquid circulation unit comprising:
a piezoelectric unit including a first electrode, a second electrode facing the first electrode, a piezoelectric element arranged between the first electrode and the second electrode;
a drive-control unit for controlling, in a state of a driving voltage generating distortion in the piezoelectric unit supplied to the first electrode and the second electrode, the distortion generated in the piezoelectric unit in a driving cycle including a first period and a second period; and
a diaphragm unit including a vibrating plate for vibrating in response to the distortion generated in the piezoelectric unit, and a pressure chamber for being transmitted vibrations of the vibrating plate, the diaphragm unit for circulating liquid flowing in and out of the pressure chamber by the vibrations of the vibrating plate, wherein
the first period includes a period during which the driving voltage supplied to either one of the first electrode and the second electrode is cut off, and
the second period includes a period during which no potential difference occurs between the first electrode and the second electrode.

20. A liquid discharge apparatus comprising:
a discharge element substrate including a plurality of discharge elements for discharging liquid;
a channel member hydraulically connected with the discharge element substrate, and including a supply channel for supplying the liquid to the discharge element substrate and a collecting channel for collecting the liquid from the discharge element substrate;
a pressure control mechanism provided with the channel member, and for controlling a pressure of liquid in the channel member; and
a liquid circulation unit, the liquid circulation unit comprising:
a piezoelectric unit including a first electrode, a second electrode facing the first electrode, a piezoelectric element arranged between the first electrode and the second electrode;
a drive-control unit for controlling, in a state of a driving voltage generating distortion in the piezoelectric unit supplied to the first electrode and the second electrode, the distortion generated in the piezoelectric unit in a driving cycle including a first period and a second period; and
a diaphragm unit including a vibrating plate for vibrating in response to the distortion generated in the piezoelectric unit, and a pressure chamber for being transmitted vibrations of the vibrating plate, the diaphragm unit for circulating liquid flowing in and out of the pressure chamber by the vibrations of the vibrating plate, wherein
the first period includes a period during which the driving voltage supplied to either one of the first electrode and the second electrode is cut off, and
the second period includes a period during which no potential difference occurs between the first electrode and the second electrode.

21. A print apparatus comprising a liquid discharge unit, the liquid discharge unit comprising:
a discharge element substrate including a plurality of discharge elements for discharging liquid;
a channel member hydraulically connected with the discharge element substrate, and including a supply channel for supplying the liquid to the discharge element substrate and a collecting channel for collecting the liquid from the discharge element substrate;
and a liquid circulation unit, the liquid circulation unit comprising:
a piezoelectric unit including a first electrode, a second electrode facing the first electrode, a piezoelectric element arranged between the first electrode and the second electrode;
a drive-control unit for controlling, in a state of a driving voltage generating distortion in the piezoelectric unit supplied to the first electrode and the second electrode, the distortion generated in the piezoelectric unit in a driving cycle including a first period and a second period; and
a diaphragm unit including a vibrating plate for vibrating in response to the distortion generated in the piezoelectric unit, and a pressure chamber for being transmitted vibrations of the vibrating plate, the diaphragm unit for circulating liquid flowing in and out of the pressure chamber by the vibrations of the vibrating plate, wherein
the first period includes a period during which the driving voltage supplied to either one of the first electrode and the second electrode is cut off, and
the second period includes a period during which no potential difference occurs between the first electrode and the second electrode.
